(19) United States
(12) Patent Application Publication
(10) Pub. No.: US 2014/0208203 A1
(43) Pub. Date: Jul. 24, 2014

(54) Key-Frame based Authoring and Generation of Highly Resizable Document Layout

(71) Applicant: Steven Shu Hsiang Tang, San Jose, CA (US)

(72) Inventor: Steven Shu Hsiang Tang, San Jose, CA (US)

(21) Appl. No.: 13/747,739

(22) Filed: Jan. 23, 2013

(51) Int. Cl. G06F 17/21

(52) U.S. Cl. CPC G06F 17/212
USPC 715/252

(57) ABSTRACT

The present invention is a software method for the authoring and generation of highly resizable document layouts that automatically adapt to a wide range of window and screen sizes spanning the desktop to smartphones by interpolating and adaptively skipping the display of document layouts mapped to multiple reference windows called key-frames such that the generated document layouts and styles in a runtime document window are adjusted to be as close to the author's intent as possible. The adaptive display-skipping technique can also be extended to support adaptive pagination of document layouts.

### CROSS-REFERENCE TO RELATED APPLICATIONS

### References Cited

U.S. Pat. No. 7,818,684 B1, Oct. 19, 2010, Smith, Rendition-based Graphical Layout Management
U.S. Pat. No. 7,484,182 B1, Jan. 27, 2009, Smith, Rendition-based Graphical Layout Management
US 2010/0188705 A1, Jul. 29, 2010, Giannetti et al., Method and Article for providing layout flexibility
U.S. Pat. No. 8,201,101 B2, Jun. 12, 2012, Wiley, Resolution Independent Layout
U.S. Pat. No. 7,210,099 B2, Apr. 24, 2007, Rohrabaugh et al., Resolution Independent Vector Display of Internet Content
U.S. Pat. No. 7,120,868 B2, Oct. 10, 2006, Salesin et al., System and Method for Adaptive Document Layout via Manifold Content

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The present invention relates generally to methods for document layout, and more particularly, to the authoring and generation of highly resizable text and graphical layout.

### BACKGROUND OF THE INVENTION

As web and mobile application interfaces get increasingly structured by the document object model (DOM) representation in HTML, they have become more sophisticated and the number of document elements embedded in them has increased significantly. This vast increase in the number of document elements has made the resizing behavior of document layout much more complex to manage. But what has made the document layout resizing behavior so much more difficult to design and predict is not just due to the increase in the number of elements in document content, but also due to the increase in the number of window sizes a document layout has to support effectively. To complicate the problem further, devices like smartphones and tablets can change their screen orientation dynamically and the proper support of this feature essentially doubles the number of window sizes a document layout needs to handle for devices.

Designing a document layout to support a wide range of window sizes is often very difficult, if not impossible. As such, many user interface designers, hereinafter referred to as document layout designers, often compromise by opting for a simpler dual-layout design strategy where a document layout with limited resizing behavior targeting a common window size is designed for desktops and laptops, and specially tailored document layouts with zero resizing behavior are designed for targeted smartphones and tablets at device-specific screen resolutions. The result is a one-size-fit-all layout for desktops and laptops that often underutilizes the available window size, and dedicated device-specific document layout designs that require labor-intensive layout customization for an increasing number of smartphones and tablet window sizes.

Adding resizing behavior to a document layout such that it resizes within a limited range of window sizes is typically a simple task. In the case where a document layout is specified in HTML, the document layout's resizing behavior can be specified in the document elements' Cascading-Style-Sheets (CSS) settings. For example, if a document element's size is specified as a percentage in CSS, the specified percentage describes the size relation between it and its containing block element that will be maintained when it initializes or when its containing block element is resized.

However, common document layout resizing behaviors, including those provided by CSS, fall short in many regards when a document layout needs to support significant variations in window sizes and content lengths as CSS adjustment can only accommodate limited layout sizes without compromising the content legibility and usability.

To provide a more effective, precise, and predictable method for the authoring and the generation of document layouts that adapt to a wide range of window sizes automatically, the present invention applies concepts from key-frame animation. In simple conceptual terms, an exemplary embodiment of an editor of the present invention lets a document layout designer specify and publish the exact document layout in terms of content, layout, and style at predefined or customized reference window sizes, hereinafter referred to as key-frames, which are chosen to approximate the targeted window sizes. An exemplary runtime document window then loads the published document and resizes it predictably over a wide range of window sizes through closest-matching key-frame-group interpolation and adaptive display-skipping.

Traditionally in animation, a key frame is a composition of graphical objects that defines the exact look of an animation sequence at a particular instance in time between the animation's starting and ending points in time. An animation editor lets an animation designer define a number of key frames at key points of an animation sequence. The animation editor then computes the missing frames in each gap between two closest-matching key frames by interpolating the graphical layouts and styles at the closest-matching key frames according to the missing frame's position in time. The end result of the interpolation computation is a continuous animation from begin to finish with seamless transitions. The benefit to the animation designer is that instead of designing all the graphical objects frame-by-frame from beginning to finish in an animation, an animation designer only has to choose and design the relatively few key-frames properly to complete an entire animation sequence. An animation designer thus gains tremendous increase in design productivity. Note that the term interpolation is used herein to mean both interpolation and extrapolation mathematically.

Applying similar key-frame animation techniques but transforming them from the temporal to the spatial dimension, the present invention enables a document layout designer to specify a document layout's resizing behavior using key-framing with layout interpolation techniques that can be applied to a document element's layout and style.

More particularly, at design time, an exemplary document layout editor enables a document layout designer to specify and publish the layouts and styles of individual document elements at selected key-frame sizes. At runtime, after loading the published elements with key-framed layouts and styles into an exemplary runtime document window, the layouts and the styles of the loaded elements will be arranged in exactly the way the document layout designer specified in the document layout editor at a key-frame size when the runtime document window size matches the key-frame size. When the runtime document window size is resized to other non-key-frame sizes, the present invention applies a closest-matching key-frame resizing technique that interpolates the mapped layouts and styles for each embedded document element from its closest matching key-frames relative to the runtime document window size.

While applying key-frame animation techniques for resizing seems relatively straight forward, enabling predictable key-frame based resizing is more challenging because choosing the closest-matching key-frames is a 2-dimensional matching problem in space as opposed to a 1-dimensional matching problem in time, and as such key-frame based resizing can generate unintended element interpolated layouts and it occurs when unintended key-frame combinations are selected for layout interpolation computation. The unintended interpolated layout effect is hereinafter referred to as interpolation aliasing.

To solve the problem of interpolation aliasing, the present invention provides key-frame groupings that define valid key-frame combinations for interpolation. When selecting the closest-matching key-frames for layout and style interpolation, the present invention stipulates that the selected key-frames belong to the same key-frame group to ensure predictable interpolation calculations without aliasing. The key-frame groupings can be authored by the document layout editor or can be pre-defined when the runtime document window loads.

Prior arts have suggested the use of interpolation of user interface layouts from multiple source layout definitions in order to generate the effective user interface layout for different window sizes but they lack methods for choosing the appropriate source layout definitions for interpolation calculations when the available source layout definitions are more than two. In a world where device screen resolutions with dynamically changeable orientations are rapidly increasing, the needed source layout definitions will be many, and having robust methods for choosing the appropriate source layout definitions for interpolation calculations becomes critical.

In addition to key-framed interpolated layouts, the present invention also provides an adaptive display-skipping technique, hereinafter referred to as skip-display mapping that can be applied to document elements with or without key-frame groupings. In particular, by using skip-display mapping, a document element can be independently specified to join or skip the display of the overall document depending on which of its mapped key-framed window is computed to be the closest-matching window relative to the runtime document window.

With the present invention, the skip-display mapping can be extended to provide adaptive pagination with fixed page breaks; For a conventional document layout, whenever the window size falls below a preset or calculated minimum size in either the X or the Y-dimension, a scroll-bar is added to the document window along the dimension where the window size falls below the minimum to handle content-overflow. While scrollbars are a common way of solving the content-overflow problem, pagination often makes the document layout more intuitive to use as a paginated document layout matches our real-life reading experiences much more closely. However, a paginated document layout is difficult to design when the document layout needs to paginate a combination of different types of overflowed document content displayed in an increasing number of different window sizes.

Note that in the present invention, adaptive-content is defined as an element resizing behavior where the element content, in addition to its layout size and style also changes in response to window resizing. Taking this definition further, adaptive-pagination is defined as an element's content being sub-divided into pages only when needed, such as the case when an element's resized layout cannot fully accommodate its content without overflowing.

By extending the skip-display mapping with a page-group element as described by the present invention, the paginated version of a document can be made to display adaptively when the document window size is close to the key-frame window mapped to display the page-group element. Still furthermore, the exact range of window sizes that causes the key-frame window mapped to display the page-group element can be customized by a separator-key-frame that is also described by the present invention.

It should be noted that other embodiments may be utilized and structural changes may be made without affecting from the scope of the present invention.

For the purposes of this document, the phrase “key-framed element” is used herein to describe a document element with its layout, style, and skip-display property mapped to multiple key-frame sizes and the phrase “key-framed HTML” is used herein to describe the HTML content comprising key-framed elements. The word “exemplary” is used herein to mean serving as an example, instance, or illustration. Any aspect or design described herein as “exemplary” is not necessarily to be construed as preferred or advantageous over other aspects or designs.

### BRIEF SUMMARY OF THE INVENTION

The present invention is a software method for the authoring and generation of highly resizable document layouts that automatically adapt to a wide range of window and screen sizes spanning the desktop to smartphones by utilizing a closest matching key-frame-group interpolation with skip-display mapping such that the generated document layouts, styles, and content are adjusted to be as close to the author's intent as possible at any window or screen size. In particular, the present invention enables the authoring and generation of resizing behavior for document elements efficiently, precisely, and predictably such that their individual layouts and styles arrange in exactly the way the document layout designer specified at window sizes matching their respective reference window sizes called key-frame sizes, while at other window sizes, their layouts and styles adjust via a closest matching key-frame-group interpolation with skip-display mapping to approximate the author's intent. The present invention also supports the authoring of paginated document content that displays adaptively in a resized document window.

### BRIEF DESCRIPTION OF THE DRAWINGS

FIG. 1 illustrates a systems view of a document layout designer and an end-user interacting with an exemplary web application system hosting the present invention involving a browser and a web server.

FIG. 2A-2C illustrate an interpolation aliasing problem occurring in a runtime window when applying common layout interpolation techniques during resizing.

FIG. 3 and FIG. 4 illustrate two instances of the browser-based editor of the web application of FIG. 1 with each creating a simulated window at a specific key-frame size that is part of a key-frame group.

FIG. 5, 6, 7, 8 illustrate the browser-based editor specifying the layouts of two elements contained in the key-frame window at different key-frame sizes and groups.

FIGS. 9A and 9B illustrate how the layout interpolation techniques of the present invention solve the interpolation aliasing problem.

FIG. 10 illustrates a block of absolutely-positioned text inserted into a key-frame window.

FIG. 11 illustrates the document layout designer changing the size of the key-frame window, the layout and the CSS font size of the block of inserted text.

FIG. 12 illustrates an interpolated layout with interpolated CSS style being generated via key-frame-group interpolated resizing for the block of text when the key-frame window is resized to a non-predetermined key-frame size.

FIG. 13 illustrates the addition of a new customized key-frame size to the pre-determined set, and causing the layout and style of the manipulated text element to be mapped to the new customized key-frame size.

FIG. 14 illustrates the deletion of the customized key-frame size.

FIG. 15 and FIG. 16 illustrate the authoring techniques of the present invention for specifying elements with skip-display mapping.

FIG. 17 illustrates the document layout designer adding a separator-key-frame to define the transition point for the elements with skip-display mapping.

FIG. 18 illustrates the document layout designer selecting the testing context menu to change the browser-based editor into testing mode.

FIG. 19A-19C illustrate the skip-display mapping behavior of the document elements in the key-framed window during resizing.

FIG. 20 illustrates the document layout designer publishing the authored HTML DOM with key-framed layouts and styles through a context menu.

FIG. 21A-21C illustrate the skip-display mapping behavior of the document elements in the runtime document window during resizing.

FIG. 22-24 illustrate using text layouts with skip-display mappings at two key-frames and a separator-key-frame to avoid the interpolation-aliasing problem of FIG. 2.

FIG. 25 and FIG. 26 illustrate the authoring of a page-group element involving two child text elements representing paginated content.

FIG. 27A-27C and FIG. 28A-28C illustrate the resizing behavior of the page-group element showing the first and second page respectively in the runtime document window.

FIG. 29A-29C illustrate a common HTML element resizing behavior involving a text element displaying a scrollbar when resized.

FIG. 30A-30C illustrate using elements with skip-display mapping to achieve an adaptively-paginated document layout design.

FIG. 31A-31B detail the skip-display mapping behavior around the transition point as defined by the separator-key-frame.

FIG. 32A-32B contrast the effect on the closest-matching bounding key-frame computation before and after adding a separator-key-frame graphically.

FIG. 33 and FIG. 34 illustrate exemplary JavaScript functions for the closest matching key-frame-group interpolation with skip-display mapping.

FIG. 35 illustrates a flowchart describing the main processing steps for the authoring of a key-framed document associated with the present invention.

FIG. 36 illustrates a flowchart describing the main processing steps for the generation of a key-framed document associated with the present invention.

In the following description of the exemplary embodiments of the present invention, references are made to the accompanying drawings which form a part hereof, and in which is shown by way of illustration specific embodiments in which the invention may be practiced. It is understood that other embodiments may be utilized and structural changes may be applied without leaving the scope of the present invention.

### DETAILED DESCRIPTION OF THE INVENTION

The present invention is described with reference to the drawings, where like reference numerals are used to refer to like elements throughout.

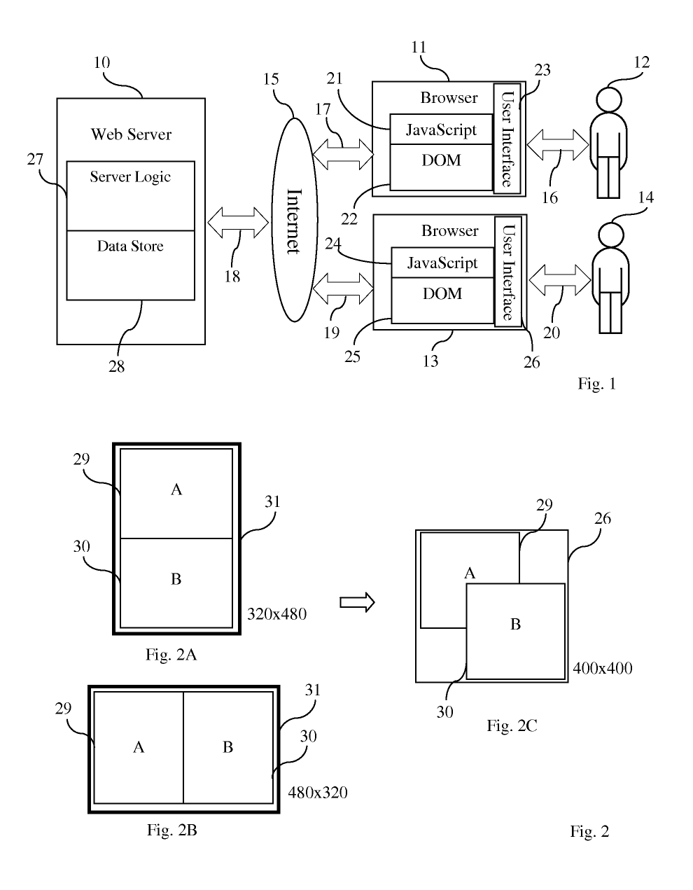

Leveraging the figures below, the following paragraphs provide detailed description for the present invention. FIG. 1 illustrates a block diagram of an exemplary embodiment of the present invention comprising a document layout designer 12 and an end-user 14 interacting with an exemplary computer system hosting the present invention. In particular, the document layout designer 12 interacts with a browser-based document layout editor 11, hereinafter referred to as the browser-based editor 11, through the interaction path 16. The browser-based editor 11 communicates with the web server 10 for loading and publishing the document content as key-framed HTML over the Internet 15 through the communication paths 17 and 18. The published document content is communicated to the server logic 27 which may further manipulate the HTML content before it is stored on the web server 10 in its data store 28, which can be a file system or a database.

Internally, the exemplary browser-based editor 11 comprises the JavaScript 21 for providing the editing of the key-framed elements. The DOM 22 illustrates the Document Object Model (DOM) for the edited key-framed HTML in the browser-based editor 11. The user interface 23 illustrates the browser-based editor 11's user interface for editing the key-framed elements.

Still referring to FIG. 1, the end-user 14 interacts with the runtime browser 13 loaded with key-framed HTML through the interaction path 20. The runtime browser 13 communicates with the web server 10 for loading the published key-framed HTML over the Internet 15 through the communication paths 18 and 19. Internally, the exemplary runtime browser 13 comprises the JavaScript 24 for generating key-framed element resizing. The DOM 25 illustrates the HTML Document Object Model of the loaded key-framed HTML in the runtime browser 13. The user interface 26 illustrates the browser user interface for manifesting the key-framed element resizing. The browser user interface 26 is equivalent to a runtime document window in a general embodiment of the present invention, and as such, the browser user interface 26 is also referred to as the runtime document window 26.

FIG. 2A-2C illustrate an interpolation aliasing problem that violates author's intent when unintended combinations of key-framed graphical layouts, often referred to as graphical source layout definitions in other literatures, are used to generate the runtime layout. For example, the interpolation aliasing occurs when the key-framed source layouts are customized for the mobile device screens in landscape and portrait modes respectively in order to use the valuable screen space more efficiently. In particular, FIG. 2A and FIG. 2B show the element 29 and 30 being laid out in a simulated window called the key-frame window 31 in an editor in the portrait mode and the landscape mode respectively. More particularly, the portrait key-frame window 31 in FIG. 2A has a key-frame size of 320×480 in terms of “width×height” in pixels while the landscape key-frame window in FIG. 2B has a key-frame size of 480×320.

Still referring to FIG. 2A-2C, the portrait key-frame window 31 in FIG. 2A tiles the element 29 and 30 vertically while the landscape key-frame window 31 in FIG. 2B tiles the element 29 and 30 horizontally. When the element 29 and 30 are loaded into the runtime document window 26 and if the landscape and portrait key-framed layouts are selected to be the source layouts for an interpolative layout system, the element 29 and 30 will be laid out in a staggered and overlapping style at an intermediate runtime document window size of 400×400 using linear interpolation as shown in FIG. 2C. In most common cases, the designer 12's intention is to maintain a non-overlapping tiling layout for the element 29 and 30, and as such, the staggered element 29 and 30 as generated in the runtime document window 26 in FIG. 2C violates author's intent and this unintended interpolation effect is hereinafter referred to as interpolation aliasing.

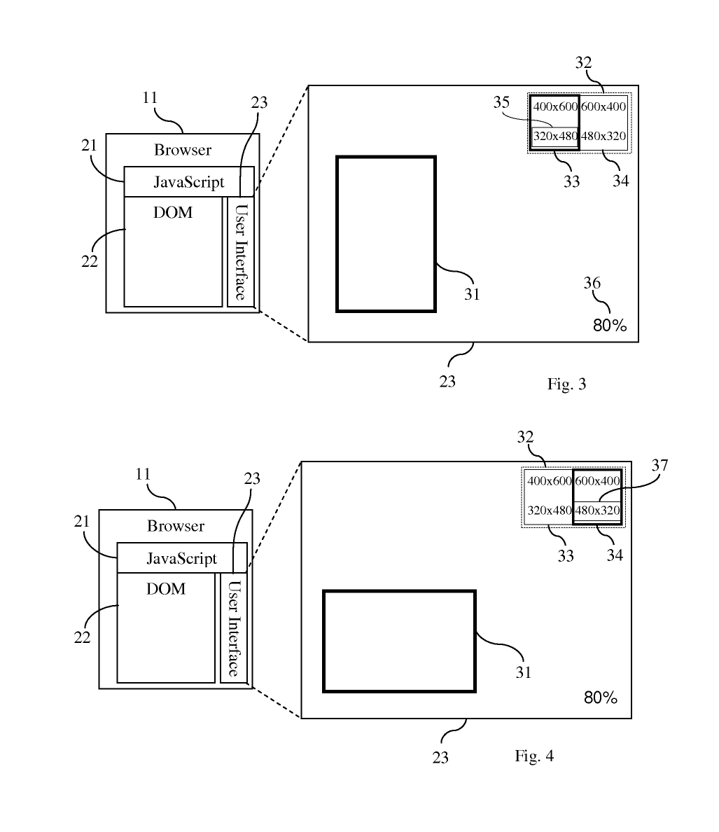

FIG. 3 illustrates the browser-based editor 11's user interface 23 sub-block being expanded into a browser-based editor window 23 on the right to show how the key-framed HTML is authored and tested. Inside the browser-based editor window 23, the top right section shows a key-frame selector 32 comprising four clickable labels, each of which represents a particular key-frame size in the format of “width×height”. Note that the four key-frame sizes have been grouped into the key-frame group 33 and 34 with each key-frame group containing key-frame sizes with similar aspect ratios, although it is important to note that groupings based on other properties of a key-framed layout such as its overall area can be applied in other embodiments.

Still referring to FIG. 3, when a key-frame label of the key-frame selector 32 is clicked, the simulated window, hereinafter referred to as the key-frame window 31 with the respective key-frame size is created inside the browser-based editor window 23. For example, if the key-frame 35's label showing 320×480 is clicked, the key-frame window 31 will be created and resized to 320 pixels in width and 480 pixels in height in the browser-based editor window 23. Note that because of window space limitations, the key-frame window 31 is scaled down by a factor of 80% as indicated by the zoom-label 36. Also note that even though in this exemplary embodiment both the key-frame selector 32 and the key-frame window 31 are implemented as HTML elements, they do not appear inside the DOM 22 as it only describes the key-framed elements inside the key-frame window 31 for the purposes of clarity.

Still referring to FIG. 3, the pre-defined key-frame group 33 and 34 can be identified explicitly by unique group ids managed by the browser-based editor 11, and their key-frame sizes do not have to share common geometric properties. The pre-defined key-frame groups can also be defined implicitly by geometric properties common to the grouped key-frame sizes and computed programmatically. For example, both key-frame sizes grouped by the key-frame group 33 share the same aspect ratio, and this shared geometric property can be used to create the key-frame group 33 mathematically that is separate from the key-frame group 34 which defines key-frame sizes with a different aspect ratio.

FIG. 4 illustrates the key-frame 37's label of 480×320 of key-frame group 34 being selected, and the key-frame window 31 is adjusted to 480 pixels in width and 320 pixels in height respectively.

Still referring to FIG. 3 and FIG. 4, the present invention does not stipulate the specific key-frame sizes or the number of key-frames to use, but experience shows that the key-frame sizes should be chosen to approximate the document window sizes a particular document layout is targeting.

Still referring to FIG. 3 and FIG. 4, the key-frame window 31 is used for mapping the layouts and the styles of its embedded document elements to particular key-frame sizes. Because a web application is used as an exemplary application to host the present invention, the document elements are implemented by HTML elements inserted in the key-frame window 31 as graphical elements with freely positioned layouts. As such, the graphical layouts of the embedded document elements inside the key-frame window 31 are implemented as absolute-positioned HTML element layouts while the styles of the embedded document elements are implemented as inline CSS-styles of the inserted HTML elements.

Still referring to FIG. 3 and FIG. 4, the mappings of the layouts and CSS-style attributes to different key-frame sizes for an inserted HTML element in the key-frame window 31 are independently recorded in the HTML element itself as element attributes and values. These recorded key-framed layouts and CSS styles are used by the closest matching key-frame-group interpolation algorithms of the present invention for calculating the interpolated layouts and CSS styles of the embedded document elements at non-key-framed window sizes.

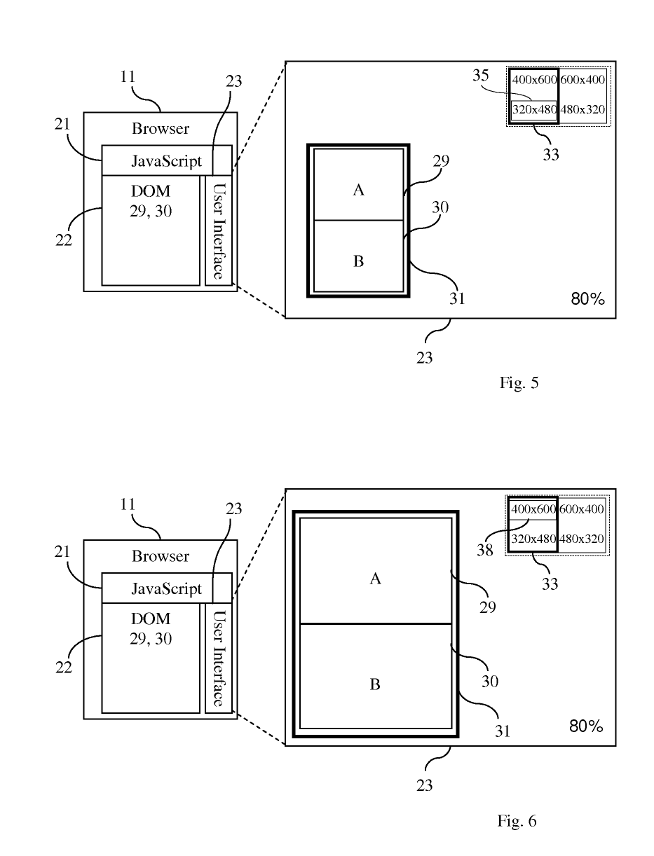

FIG. 5 to FIG. 8 illustrate how the key-frame-group interpolated resizing generates runtime layouts that approximate the author's intent without the interpolation aliasing effect. In particular, FIG. 5 shows the document layout designer 12 choosing the key-frame 35 of the frame-size group 33 and specifying the key-framed element 29 and 30 be tiled vertically in the key-frame window 31 at the key-frame size of 320×480. Next, as shown in FIG. 6, the document layout designer 12 chooses the key-frame 38 of the frame-size group 33 and specifies that the key-framed element 29 and 30 be tiled vertically in the key-frame window 31 at the key-frame size of 400×600.

Then the layout specification process is repeated in the second key-frame group 34. Specifically, FIG. 7 shows the document layout designer 12 choosing the key-frame 37 of the frame-size group 34 and specifying the key-framed element 29 and 30 be tiled horizontally in the key-frame window 31 at the key-frame size of 480×320. Next, as shown in FIG. 8, the document layout designer 12 chooses the key-frame 39 of the frame-size group 34 and specifies that the key-framed element 29 and 30 be tiled horizontally in the key-frame window 31 at the key-frame size of 600×400.

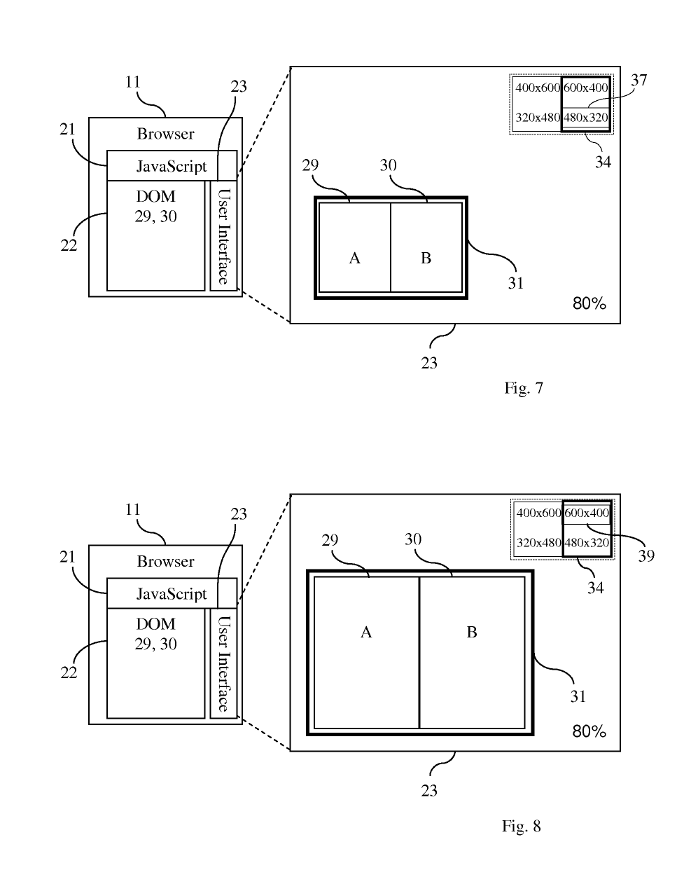

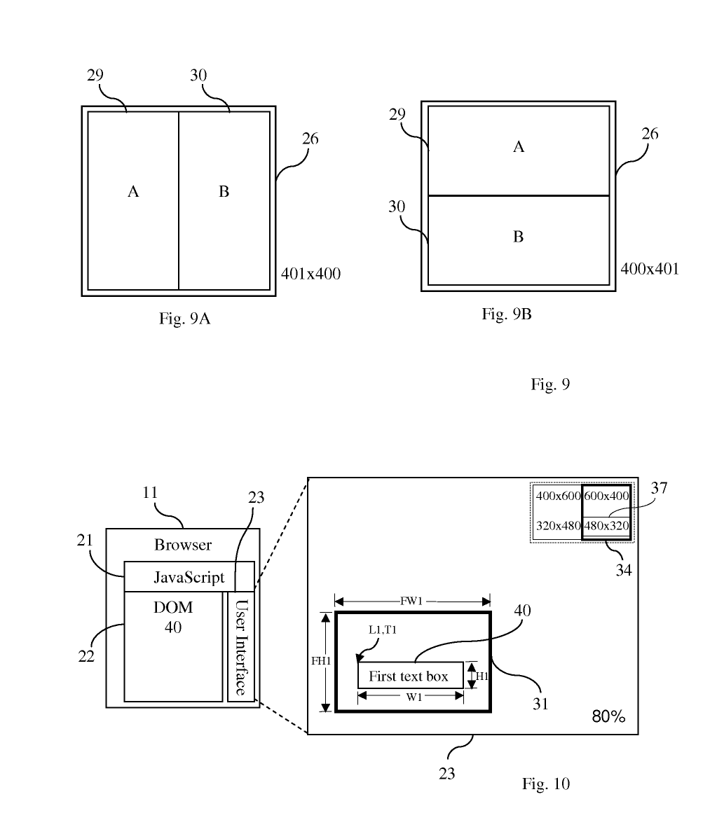

FIG. 9 illustrates the exemplary runtime document window 26 having loaded the key-framed elements 29 and 30, and because the source key-frames selected for layout interpolation calculations are limited to those found in either the key-frame group 33 or the key-frame group 34 of FIG. 5 to FIG. 8, the interpolation-aliasing causing key-frame combinations like (320×480, 480×320), (320×480, 600×400), (400×600, 480×320), and (400×600, 600×400) will not be allowed to participate in key-frame-group interpolation calculations; only valid key-frame combinations of (320×480, 400×600) and (480×320, 600×400) are allowed, and as such, the interpolation-aliasing effect cannot occur in an exemplary implementation of the present invention.

More particularly, FIG. 9A shows the runtime document window 26 with a layout of 401×400 in width and height that is more closely matching the landscape-style key-frames contained in the key-frame group 34, and as a result, the runtime document window 26 tiles the document elements 29 and 30 horizontally proportionately based on their respective key-framed layouts as specified in the key-frame window 31 in FIG. 7 and FIG. 8. In contrast, FIG. 9B shows the runtime document window 26 with a layout of 400×401 in width and height that is more closely matching the portrait-style key-frames contained in the key-frame group 33, and as a result, the runtime document window 26 tiles the document elements 29 and 30 vertically proportionately based on their respective key-framed layouts as specified in the key-frame window 31 in FIG. 5 and FIG. 6.

FIG. 10 to FIG. 20 illustrate the detailed steps involved in the authoring and publishing of the key-framed layouts as implemented by the exemplary browser-based editor 11 of the present invention. In particular, FIG. 10 illustrates the document layout designer 12 having inserted an absolutely positioned HTML text element 40 with a default point size of 12 points into the key-frame window 31 at 480 pixels in width by 320 pixels in height as indicated by the selected key-frame 37's label. A corresponding element 40 has been created in the DOM 22 to represent the text element 40 in the key-frame window 31. More particularly, an attribute by the name “keyLayouts” of the element 40 has recorded the geometry, in terms of “left,top,width,height”, as “L1,T1,W1,H1” and the CSS style as “font-size: 12pt” of the text element 40 are mapped to the key-frame size of FW1×FH1 which equals 480×320.

FIG. 11 illustrates the key-frame 39's label of “600×400” having been selected by the document layout designer 12, and the key-frame window 31 adjusted proportionately. Besides, the document layout designer 12 has resized the text element 40's layout size to “L2,T2,W2,H2” and increased its font size to 18 points through the context menu 41. The “keyLayouts” attribute of the element 40 in the DOM 22 has additionally recorded that the geometry “L2,T2,W2,H2” and the CSS style of “font-size: 18pt” of the text element 40 are mapped to the key-frame size of FW2×FH2 which equals 600×400.

It is important to note that even though that different layouts and styles mapped to respective key-frame sizes for the element 40 are created through the browser-based editor 11, the present invention recognizes that programmatic creation of such layout and style mappings to any key-frame sizes for any element in the DOM 22 is possible and even preferable in other embodiments.

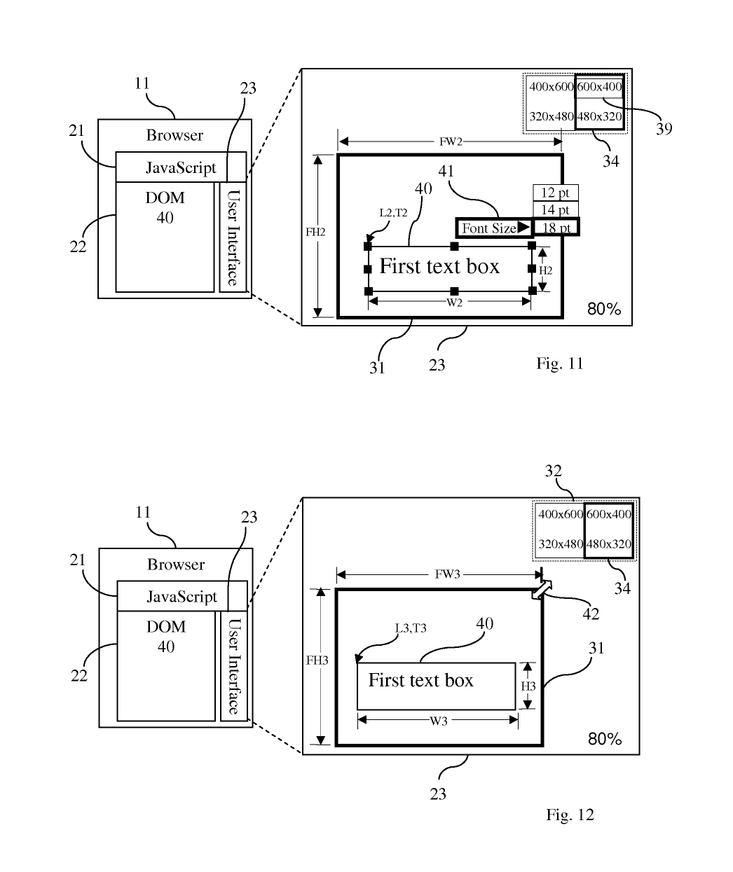

FIG. 12 illustrates the document layout designer 12 dragging the upper right corner 42 of the key-frame window 31 where a resize cursor appears. Note that as the document layout designer 12 starts resizing the key-frame window 31, the closest-matching key-frame group 34 for interpolation calculation is highlighted, and the frame width and height, FW3 and FH3 of the key-frame window 31 change continually which triggers the continual execution of the closest matching key-frame interpolated resizing that causes the layout geometry, L3,T3,W3 and H3, and the style of the text element 40 to adjust proportionately.

Still referring to FIG. 12, if the key-frame window 31 is resized such that FW3×FH3 is equal to 480×320, as FW1×FH1 of FIG. 10, then the L3, T3, W3 and H3 are interpolated to L1, T1, W1 and H1, and the font size of the text element 40 is interpolated to 12 points as in FIG. 10. Similarly, if the key-frame window 31 is resized such that FW3×FH3 is equal to 600×400, as FW2×FH2 of FIG. 11, then the L3, T3, W3 and H3 are interpolated to L2, T2, W2 and H2, and the font size of the text element 40 is interpolated to 18 points as in FIG. 11.

Still referring to FIG. 12, when the key-frame window 31 is resized and as long as FW3×FH3 form a landscape layout, the key-frame group 34 will be selected and the 480×320 and 600×400 will be computed as the closest matching key-frame sizes relative to the key-frame window 31 by the closest matching key-frame computation, and the layout L3, T3, W3 and H3 respective relationships can be mathematically described by the following formulas:

L3=(FW3−FW1)/(FW2−FW1)*(L2−L1)+L1;

T3=(FH3−FH1)/(FH2−FH1)*(T2−T1)+T1;

W3=(FW3−FW1)/(FW2−FW1)*(W2−W1)+W1;

and

H3=(FH3−FH1)/(FH2−FH1)*(H2−H1)+H1;

Note that the font size of the text element 40, and all its other numerical CSS values, may be interpolated by taking the minimum or the average frame size ratios in width and height. For example, the font size of the text element 40 in FIG. 12 can be described by:

Font size=Math·min((FW3−FW1)/(FW2−FW1),(FH3−FH1)/(FH2−FH1))*(18pt−12pt)+12pt;

The key thesis statement of the key-frame based resizing algorithm is that the layouts and styles of the document elements arrange themselves in exactly the way the document layout designer specified at key-frame sizes and they adapt to other window sizes via a closest matching key-frame-group interpolation algorithm. Note also that while the illustrated example uses the two closest matching key-frame sizes for layout interpolation calculations, the present invention accommodates the use of more sophisticated interpolation algorithms that base its interpolation calculation on the N closest matching key-frame sizes from the same key-frame group where N is a number greater or equal to two.

Also note that even though the text element 40's layout is specified using absolute-positioned CSS, the authoring and generation of key-frame-group interpolated layouts can be applied to text layouts by interpolating their sizes only since the positioning of a text element is handled by the text layout system.

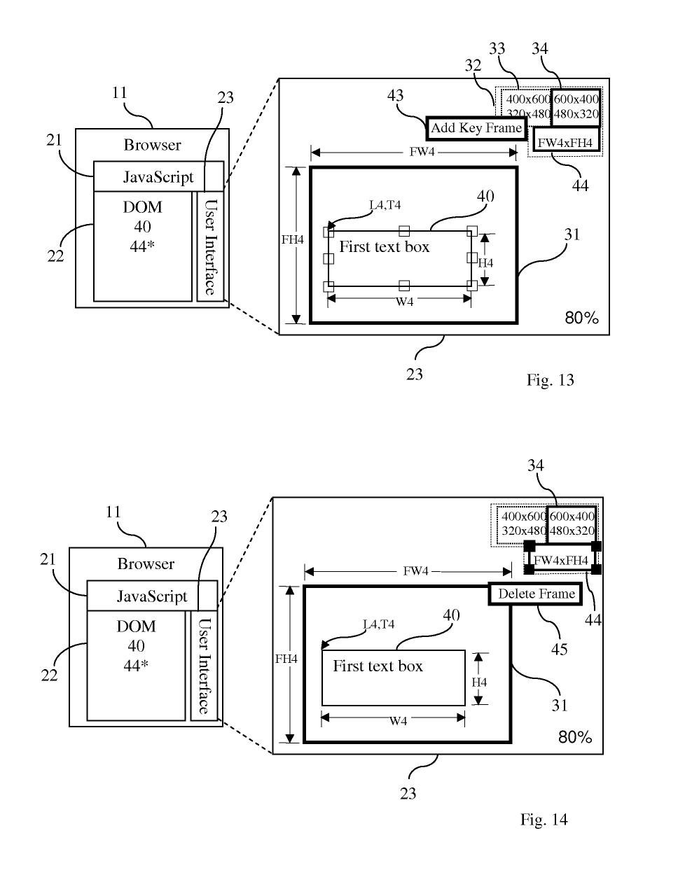

FIG. 13 illustrates the document layout designer 12 dynamically adding a customized key-frame size to a key-frame group. In particular, FIG. 13 shows that the document layout designer 12 has further manipulated the layout of the text element 40 to “L4,T4,W4,H4”. By right-clicking on the key-frame group 34, the document layout designer 12 creates and selects a “Add Key Frame” context menu 43, and a key-frame 44's label of “FW4×FH4” is added to the key-frame group 34 inside the key-frame selector 32 to indicate that the corresponding new key-frame size is created in the key-frame-group 34. The layout and style, like CSS style of the text element 40 have been recorded to map to the newly added customized key-frame size FW4×FH4.

Note that if the document layout designer 12 wishes to change the key-frame group the newly created key-frame 44 belongs to, he can change the currently selected key-frame group before creating the new key-frame. For example the layout designer 12 can select the key-frame group 33 before selecting the context menu 43. If the document layout designer 12 wishes to create the newly created key-frame to belong to a new key-frame group, he can unselect the currently selected key-frame group before creating the new key-frame.

Moreover, each key-frame group is identified by a unique id called a “groupId” that is managed by the browser-based editor 11. When the key-framed layouts associated with the text element 40 are persisted into the data store 28 of the server 10, the “groupIds” are persisted together, and when the text element 40 is reconstituted in the runtime document window 26, the key-frame group 33 and 34 are reconstituted based on the persisted key-frame “groupIds”.

Note that besides the element 40, the DOM 22 also captured the newly added key-frame 44, but because the key-frame 44 is an attribute, an asterisk is drawn next to the separator-key-frame 44's label to differentiate it from other DOM elements in the DOM 22

FIG. 14 illustrates that the document layout designer 12 dynamically deleting the customized key-frame size. In particular, FIG. 14 shows the document layout designer 12 right-clicking on the customized key-frame 44's label and selecting a “Delete Frame” context menu 45, and the customized key-frame 44 and its label will be removed from the key-frame-group 34. In addition, the recorded graphical layout and style of the text element 40 mapped to the customized key-frame size FW4×FH4 will be erased.

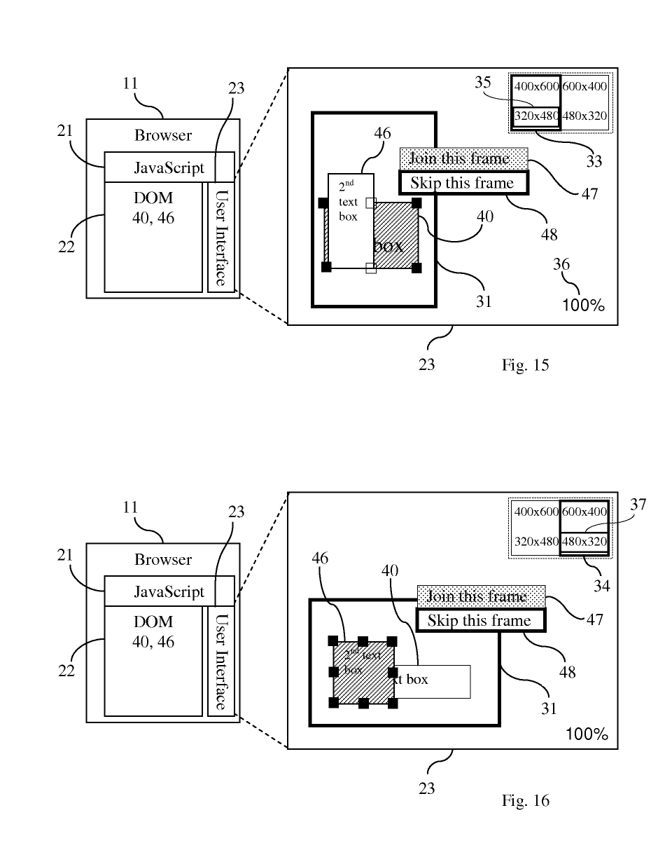

FIG. 15 and FIG. 16 illustrate the application of the skip-display mapping of the present invention such that the content of the document elements itself will adaptively display or hide depending on the size of the runtime document window. In particular, the skip-display mapping provides a way for the document layout designer 12 to specify whether a particular document element will join or skip the display in the runtime document window should a mapped key-frame size be computed as the closest-matching key-frame size.

More particularly, in FIG. 15, the key-frame window 31 contains two interchangeable text elements, the text element 40 and 46. The text element 40 has a layout more fitting for display in a landscape style runtime document window while the text element 46 is more fitting for display in a portrait style runtime document window. As such, the layout designer 12 adjusts the key-frame window 31 to 320×480 by selecting the key-frame 35's label, and at this portrait-style key-frame window size, the element 40 is specified to skip its display should the frame-size 320×480 be computed as the closest-matching frame size using a context menu option 48. The layout designer 12 may also apply the context menu option 48 on the element 40 at the 400×600 key-frame size such that the element 40 will skip its display in all portrait-style runtime document window sizes. A context menu option 47 allows the selected document element to re-join the display in the runtime document window 26 near the selected key-frame size.

In FIG. 16, the layout designer 12 adjusts the key-frame window 31 to 480×320 by selecting the key-frame 37's label, and at this landscape-style key-frame window size, the element 46 is specified to skip its display should the frame-size 480×320 be computed as the closest-matching frame size using the context menu option 48. The layout designer 12 may also apply the context menu option 48 on the element 46 at the 600×400 key-frame size such that the element 46 will skip its display in all landscape-style runtime document window sizes.

When the key-framed document elements with skip-display mappings are loaded in a runtime document window, either the element 40 or 46 will skip its display and the transition point for skip-display mapping is near the average window size of the two mapped key-frame windows. Referring to the document element 40 and 46 from FIGS. 15 and 16, the display in the runtime document window will switch from the element 40 to 46 or vice versa near the window size of 400×400. It is important to note that while elements with skip-display also need to be mapped to key-frames, their mapped key-frames do not need to belong to the same key-frame group.

If the document layout designer 12 wishes to fine-tune the window size of the transition point for skip-display mapping, he can add a separator-key-frame with a size in between the closest-matching bounding key-frames in terms of width and height, and referring to FIGS. 15 and 16, the closest-matching bounding key-frame sizes are 320×480 and 480×320. Technically, a separator-key-frame behaves similar to a regular key-frame in that it records the layouts, CSS and other attributes of the document elements as mapped to the key-frame size. However, unlike a regular key-frame, a separator-key-frame defines a new key-frame group with its two closest-matching bounding key-frames added to it.

In addition, unlike a regular key-frame, when a separator-key-frame is computed to be the closest-matching key-frame, the skip-display mapping of a key-framed element will be defined by the closest-matching non-separator bounding key-frame unless the runtime document window size is identical to the separator-key-frame's own size, in which case an element's skip-display mapping will be defined by the separator-key-frame itself.

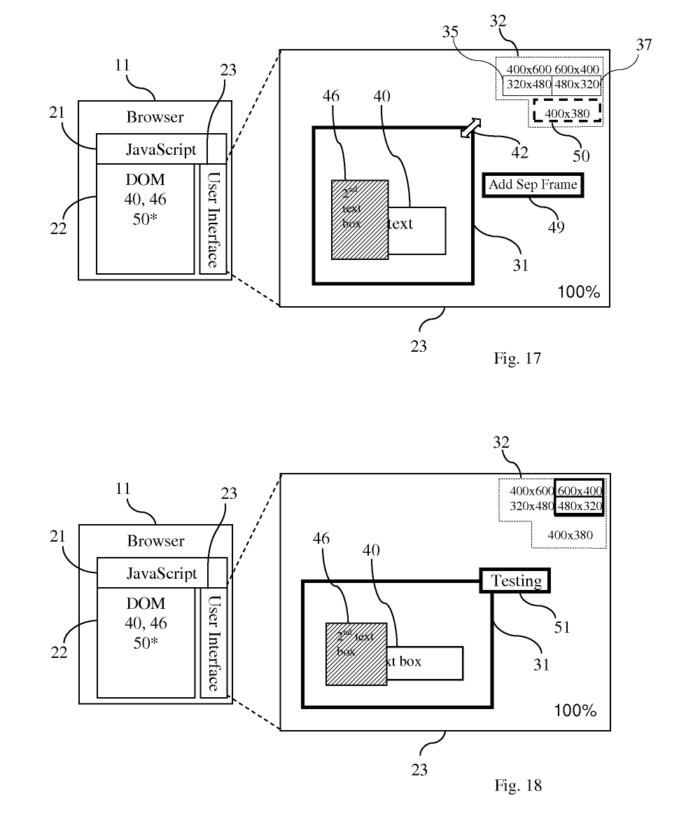

FIG. 17 shows the use of a separator-key-frame to specify the exact transition-point for skip-display mapping. In particular the document layout designer 12 has resized the key-frame window 31 to a size of 400×380 by dragging the corner 42. The document layout designer 12 has also selected the context menu 49 to add this key-frame size as a separator-key-frame 50, and as a result, the separator-key-frame 50's label is added to the key-frame selector 32. Note that the separator-key-frame 50's label is drawn with a dashed border instead of a solid border to differentiate it from non-separator key-frames.

Technically, the separator-key-frame 50 itself defines a new key-frame group and its closest-matching bounding key-frames, the key-frame 35 of 320×480 and the key-frame 37 of 480×320 are added to this new key-frame group. When the element 40 and 46 are loaded in a runtime document window with a size bounded between 400×380 and 480×320, the element 40 will be displayed, and when its size is bounded between 400×380 and 320×480, the element 46 will be displayed. If the runtime document window is sized exactly at 400×380, the element 40 will be displayed as specified by the separator-key-frame in FIG. 17. Note that besides the element 40 and 46, the DOM 22 also captured the newly added separator-key-frame 50, but because the separator-key-frame 50 is an attribute, an asterisk is drawn next to the separator-key-frame 50's label to differentiate it from other DOM elements in the DOM 22.

FIG. 18 shows the document layout designer 12 selecting the testing context menu 51 and the browser-based editor 11 goes into the testing mode. The key-frame window 31 can then be freely resized with all key-frame-group interpolated resizing and skip-display mapping algorithms enabled to faithfully reproduce the end-user's observed resizing behavior when the document elements in the DOM 22 are loaded into a runtime document window.

FIG. 19A-19C illustrate how elements with skip-display mapping of the present invention behave in the key-frame window 31 in testing mode when its closest-matching key-frame algorithm is enabled. In particular, in FIG. 19A-19C, the document layout designer 12 resizes the key-frame window 31 by dragging the upper-right corner 42, and the key-frame size selector 32 continually highlights the closest-matching key-frame size and group by drawing a border around their respective key-frame labels. In particular, in FIG. 19A, the closest-matching key-frame size is computed to be 480×320 relative to the key-frame window 31, and since the element 46 has been specified to skip its display at the key-frame size 480×320, only the element 40 is displayed in the key-frame window 31. Similarly, in FIG. 19C, the closest-matching key-frame size is computed to be 320×480 relative to the key-frame window 31, and since the element 40 has been specified to skip its display at the key-frame size 320×480, only the element 46 is displayed in the key-frame window 31.

In FIG. 19B, the intermediate window size of the key-frame window 31 has the average size of the key-frame window 31 in FIG. 19A and FIG. 19C which is 400×400, the closest matching key-frame algorithm executed by the JavaScript 21 determines that the closest-matching key-frame is the separator-key-frame with a size of 400×380, and the bounding key-frame relative to it and the key-frame window 31 is 320×480 because the key-frame window's height of 400 is between 380 and 480. Since the text element 40 is specified to skip its display at the key-frame size of 320×480 in FIG. 15, only the text element 46 is displayed in the key-frame window 31 in FIG. 19B.

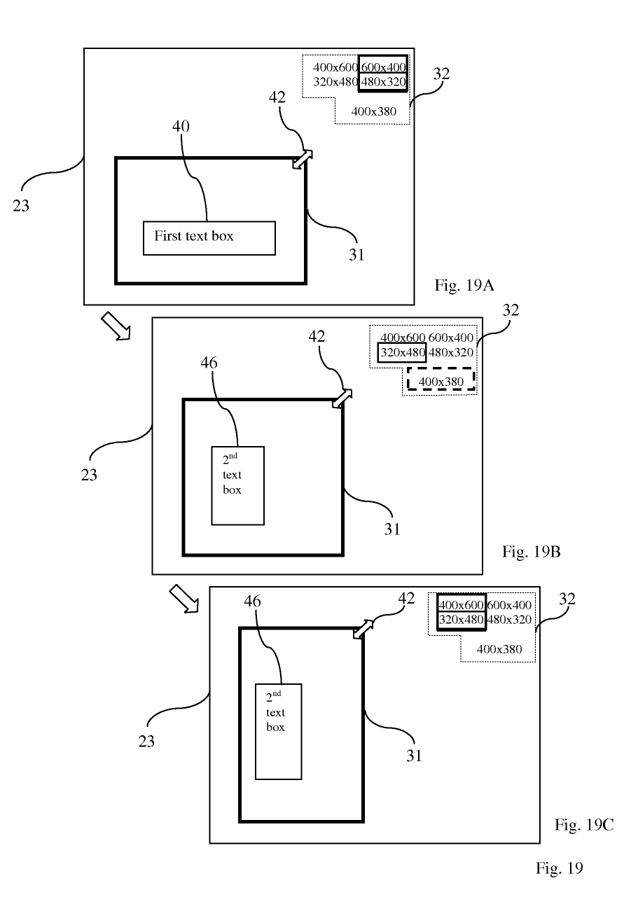

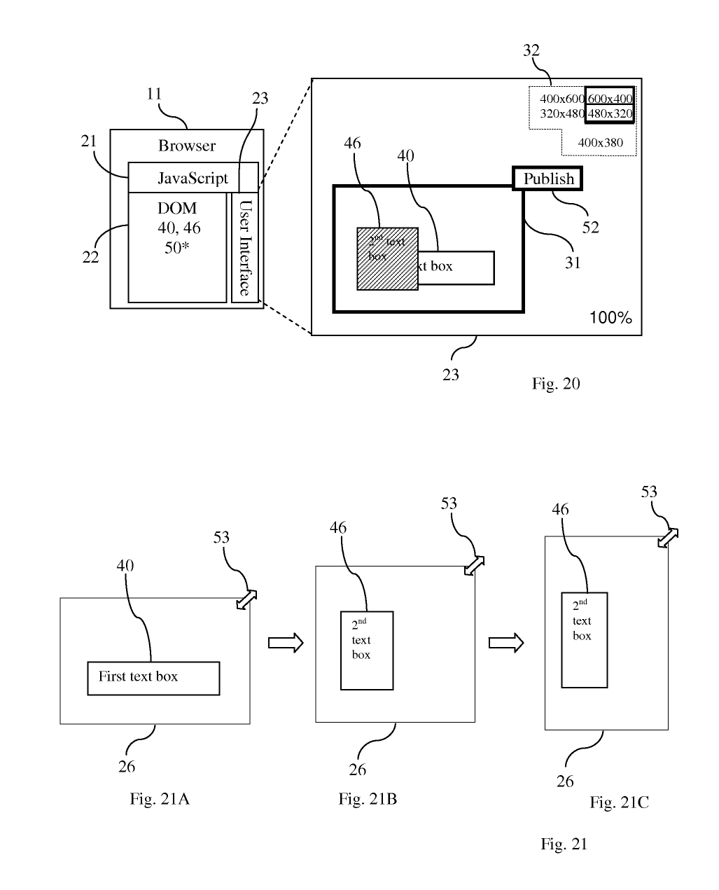

FIG. 20 shows the document layout designer 12 opening the publish context menu 52 and selecting it, and the browser-based editor 11 extracts the document elements of the key-frame window 31 as key-framed HTML representing the DOM 22 and sends it over to the web server 10 for persistence.

FIG. 21A-21C illustrate the skip-display mapping of the runtime document window 26 behaving identically as in the key-frame window 31 in testing mode in FIG. 19A-19C. In particular, the closest matching key-frame-group interpolated resizing and skip-display mapping algorithms are always enabled in the runtime document window 26. More particularly, as triggered by the user 14 resizing the corner 53, the window resizing sequence of the runtime document window 26 from FIG. 21A-21C matches that of FIG. 19A-19C identically when the size of the runtime document window 26 matches that of the key-frame window 31 respectively.

FIGS. 22 to 24 illustrate how elements with skip-display mapping specified at two key-frames can be applied to generate a highly-resizable layout that avoids the interpolation aliasing described in FIG. 2. Note that FIGS. 22 to 24 also illustrate that the key-framed elements with skip-display mapping can be applied to text layouts in addition to graphical layouts; all document elements 54 to 59 participating in the DOM 22 for demonstrating the use of skip-display mapping are text elements.

More particularly, FIG. 22 illustrates the element A and B of FIG. 2A replicated as the element 55 and 56 respectively. In addition, both element 55 and 56 have been inserted as separate row elements of the table element 54 and specified to display at the key-frame 35 of 320×480. In addition, the element A and B of FIG. 2B have also been replicated as element 58 and 59 respectively, and they have been inserted as column elements of the table element 57 which is specified to skip its display at the key-frame 35. As such, the key-frame window 31 shows the portrait layout of element A and B as in FIG. 2A.

Still referring to FIG. 22, both table 54 and 57 are specified to acquire 100% width and 100% height of the key-frame window 31. The element 55 and 56 have been specified to acquire 100% width and 50% height of their parent table element 54, while the element 58 and 59 have been specified to acquire 50% width and 100% height of their parent table element 57. Note that the DOM 22 shows the respective element 54 to 59 in the DOM tree, and the elements displaying in the current key-frame are displayed in bold-face. Also note that the row and column elements are not shown in the DOM 22 to simplify the DOM structure.

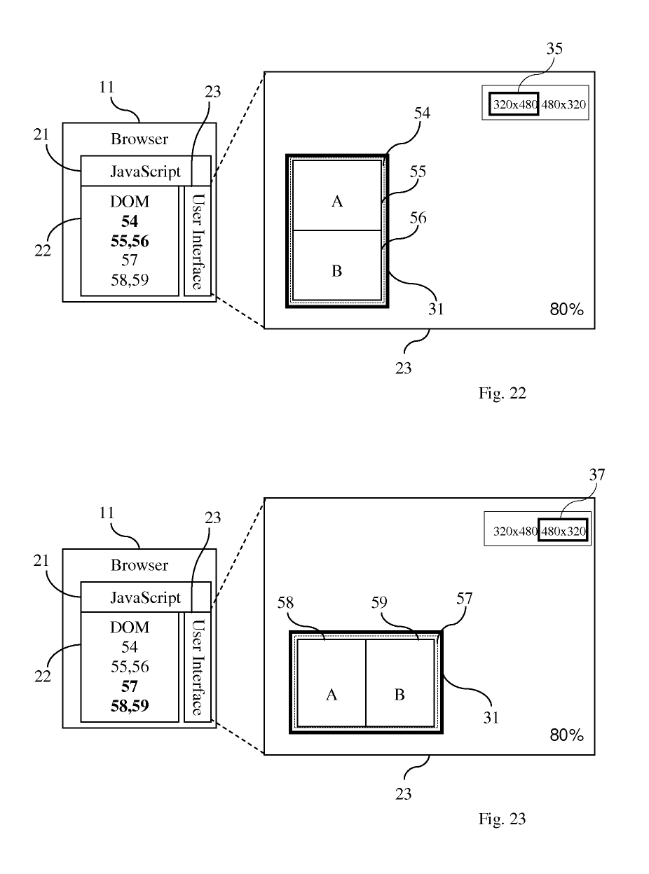

FIG. 23 illustrates that at the key-frame 37 of 480×320 at which the table 54 is specified to skip its display and the table 57 is specified to display, as a result the key-frame window 31 shows the landscape layout of element A and B as in FIG. 2B.

When the key-frame window 31 is resized to any other sizes, the closest-matching key-frame computation of the present invention will select either the key-frame 35 or the key-frame 37 as closest-matching, and the element layout of the element A and B will either be portrait or landscape without interpolation aliasing.

Similar to that of FIG. 17, if the transition point for the closest-matching computation between two key-frames needs to be customized, a separator-key-frame can be applied. FIG. 24 illustrates a separator-key-frame 50 of 400×420 being added by using the context menu 49.

With the addition of the key-frame 50 at 400×420, and at a hypothetical runtime window size of 400×410, the closest-matching bounding key-frame will become the key-frame at 480×320 instead of 320×480, and the landscape style layout of element 58 and 59 of FIG. 23 will be displayed.

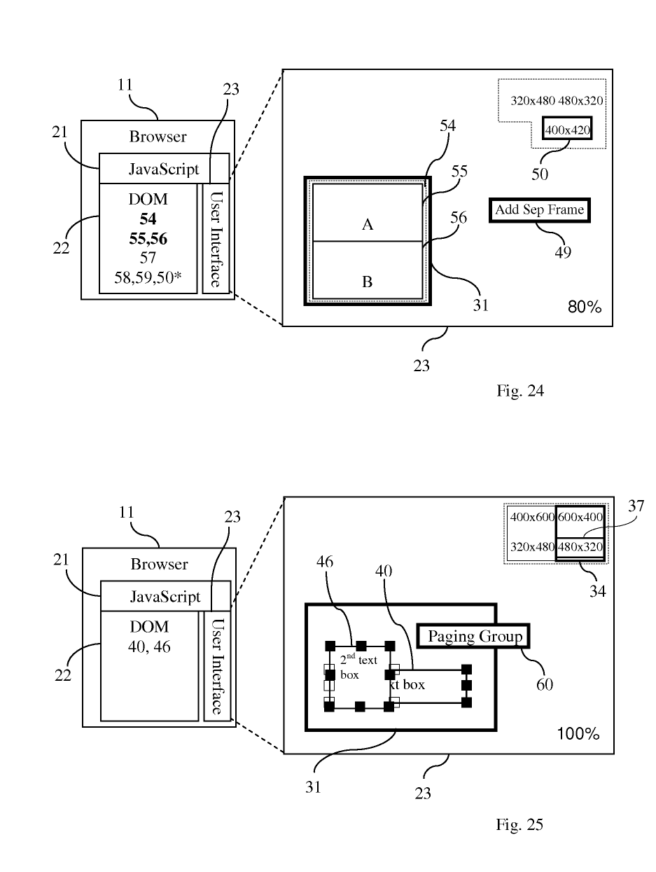

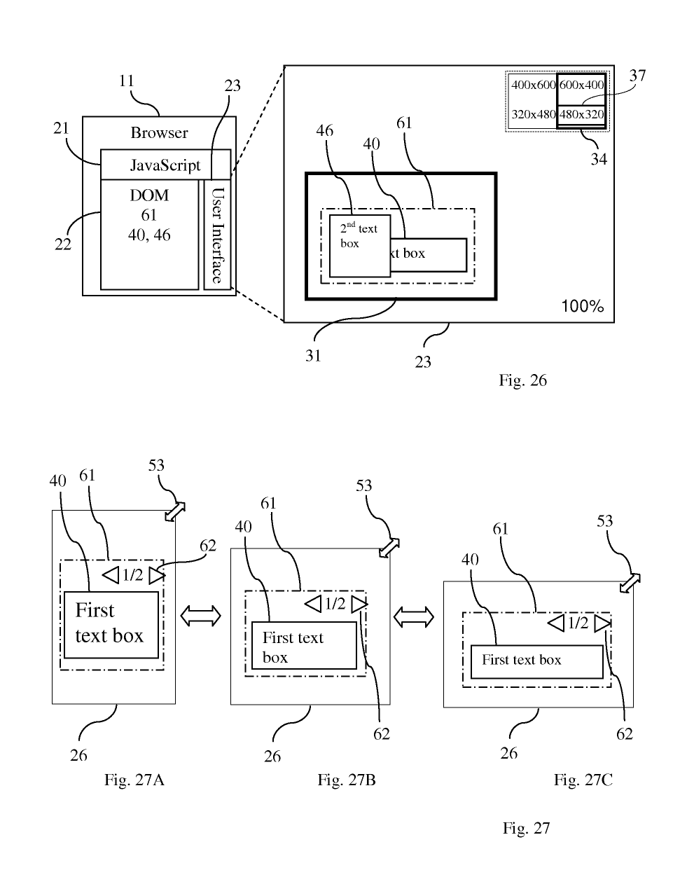

FIG. 25 and FIG. 26 illustrate the authoring of paginated content using a page-group element. In particular, FIG. 25 shows the document layout designer 12 selecting the text element 40 and 46 together, then opening and selecting a “Paging Group” context menu 60. FIG. 26 shows a page-group element 61 created after the document layout designer 12 selecting the context menu 60 from FIG. 25. The page-group element 61's respective document element 61 is inserted in the DOM 22 and it becomes the parent element of the element 40 and 46.

Still referring to FIG. 26, note that the page-group element 61 is a group element supporting scaling like a graphical group element. Note also that during the authoring of the page-group element 61, the page-group element's paging algorithm is disabled and all of its child elements are shown to facilitate the editing of its DOM structure. When tested or loaded into a runtime document window, a page-group element only shows one of its child elements as controlled by a paging user-interface widget.

It is important to note that even though that the page-group element 61 is created through the browser-based editor 11, the present invention recognizes that programmatic creation of page-group elements in the DOM 22 is possible and even preferable in embodiments where on-demand creation of a paginated content is desired.

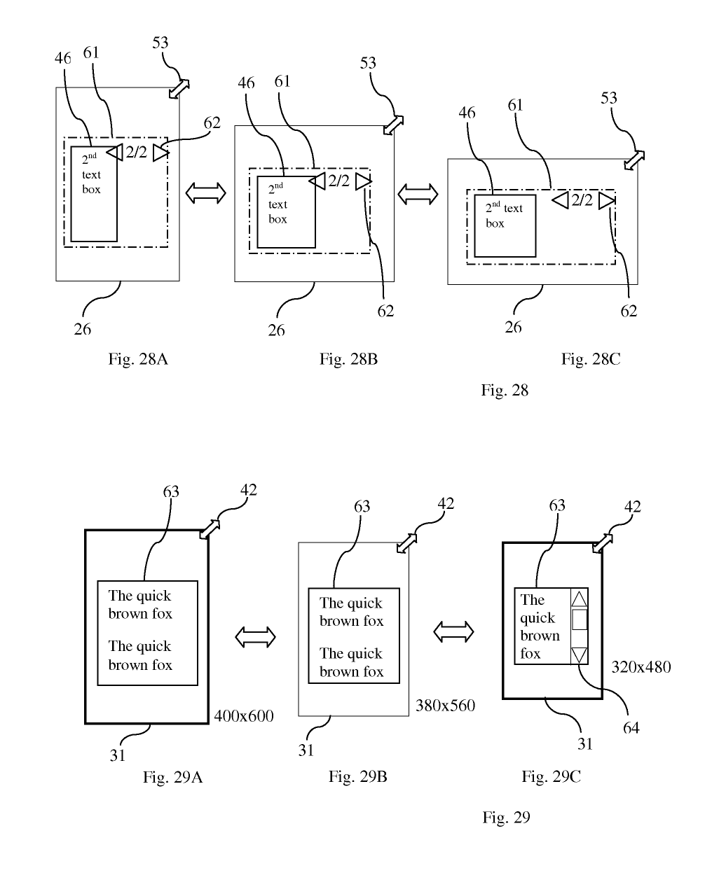

FIG. 27A-27C and FIG. 28A-28C illustrate how the page-group element 61 behaves when it is loaded in the runtime document window 26 and its paging algorithm is enabled. In the exemplary embodiment, the paging algorithm can also be tested in the browser-based editor window 23 in test mode, and the disabling and enabling of the testing mode can be achieved through the Testing context menu 51 in the browser-based editor window 23 of FIG. 18. In particular, when the browser-based editor window 23 is in the test mode, the paging algorithm for all embedded page-group elements is enabled.

More particularly, FIG. 27A-27C and FIG. 28A-28C show the paging user interface widget 62 being created automatically in top-right corner of the page-group element 61. Moreover, the paging user interface widget 62 lets the end-user 14 control which of the page-group element 61's child element to make visible. Furthermore, FIG. 27A-27C show that the runtime document window 26's upper-right corner 53 being dragged and a resize-cursor appears, and no matter whether the runtime document window 26 is resized from FIG. 27A to FIG. 27C or vice versa, the runtime document window 26 triggers the key-frame-group interpolated resizing of the page-group element 61's visible child element only.

Still referring to FIG. 27A-27C, because the page-group element 61 is showing its first child only, as indicated by the “1/2” label of the paging user interface widget 62, only the text element 40 is shown and resized. Similarly, referring to FIG. 28A-28C, because the page-group element 61 is showing its second child only, as indicated by the “2/2” label of the paging user interface widget 62, only the text element 46 is shown and resized.

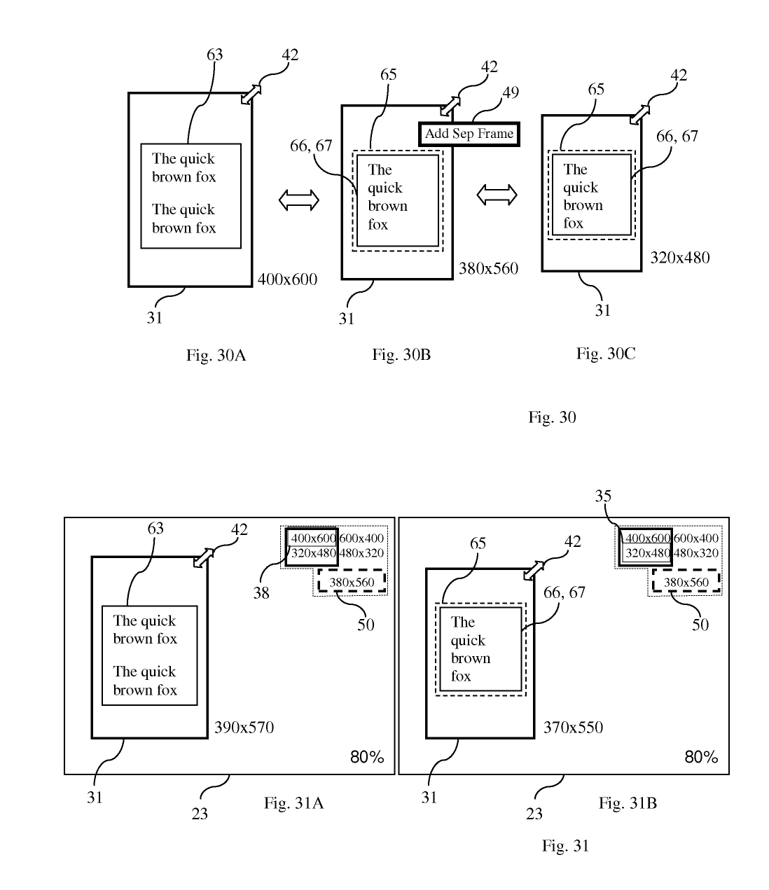

FIG. 29A-29C and FIG. 30A-30C contrast a scrollbar-enabled document layout design with one supporting an adaptively-paginated document layout design as enabled by the present invention. Specifically, FIG. 29A shows a key-framed text element 63 inserted into the key-frame window 31 and its upper-right corner 42 is dragged to resize the key-frame window 31 from 400×600 to 320×480 in FIG. 29C. In particular, when the key-frame window 31 is resized to a size of 320×480 shown in FIG. 29C, the text element 63 becomes flattened via key-frame-group interpolated resizing and its layout becomes too small to show all its text vertically, and as such, a vertical scrollbar 64 is automatically generated for the text element 63 unless its CSS specifies a “overflow:hidden” style.

FIG. 29B illustrates the point where the content of the text element 63 starts to overflow at the key-frame window size of 380×560 as the key-frame window 31 is resized between 400×600 and 320×480, and this overflow-point consists of a range of window sizes depending on the content and the CSS style of the text element 63.

Very often, a document layout with a scrollbar design is less effective than one with a paginated design, but the latter is often difficult to design properly as page breaks are difficult to manage correctly for a wide range of document layouts fitting inside different window sizes.

FIG. 30A-30C illustrate how such an adaptively-paginated document layout can be generated by applying the present invention using a page-group and a separator-key-frame. Specifically, the key-framed text element 63 with the full text content has been inserted into the key-frame window 31. The element 63 is specified to display at the key-frame size 400×600 and to skip its display at the key-frame size 320×480. Separately, the full text in the text element 63 of FIG. 30A has been subdivided into the text element 66 and 67 displaying without overflowing at the key-frame size of 320×480. Both the text element 66 and 67 have been inserted into a page-group element 65, which is specified to display at the key-frame size 320×480 as in FIG. 30C and to skip its display at the key-frame size 400×600. In addition, after resizing the key-frame window 31 by dragging the corner 42, the document layout designer 12 opens and selects the context menu 49 and a separator-key-frame is created at the key-frame window size of 380×560 which is the key-frame size when the content of the text element 63 overflows. Furthermore, as shown by FIG. 30B, if the runtime window is sized exactly as the separator-key-frame at 380×560, the page-group element 65 will display while the text element 63 will skip its display.

In the exemplary HTML-based implementation, the page-group element 65 is a DIV element while the child text elements 66 and 67 are SPAN elements. In terms of scaling behavior, the page-group element 65 behaves like a graphical group element but since the DIV element does not support graphical transformation, the scaling of the DIV element is implemented by translating and resizing the DIV's child elements through CSS manipulations recursively.

It is important to note that the page-group element and its child elements are all independently key-framed. As such, both the key-frame-group interpolation and the skip-display mapping calculations are performed recursively from the root element of the DOM tree all the way to each individual leaf-element.

FIGS. 31A and 31B illustrate that a separator-key-frame 50 of 380×560 has been created, and its two closest-matching bounding key-frame 38 and 35 of 400×600 and 320×480 respectively have been added to the separator-key-frame 50 as its group members.

Furthermore, FIG. 31A and FIG. 31B illustrate the effects of the separator-key-frame as the document layout designer 12 resizes the key-frame window 31 near the frame size of the separator-key-frame. In particular, FIG. 31A shows that when the key-frame window 31 acquires a size of 390×570 that is slightly larger than the frame size of the separator-key-frame, the closest-matching key-frame is calculated as the separator-key-frame and the key-frame of 400×600 of FIG. 31A, is the bounding key-frame for computing skip-display mapping. As such, the page-group 65 is skipped and only the text element 63 is displayed.

FIG. 31B shows that when the key-frame window 31 acquires a size of 370×550 that is slightly smaller than the frame size of the separator-key-frame. At this size the closest-matching key-frame computation still determines the separator-key-frame is the closest-matching key-frame, and the closest-matching bounding key-frame becomes the key-frame 320×480 which is used for determining skip-display mapping. As such, the page-group 65 is displayed and the text element 63 is skipped.

More broadly, by applying elements with skip-display mapping and a page-group element, a document layout designer can create an adaptively-paginated document layout using the following exemplary technique; Assuming the document content needs to accommodate a big and a small window size mainly, the document layout designer can create two versions of the document content; the first is a full-size version for accommodating the big window size while the second version of the document content is the first one broken down into content pages accommodating the small window size without overflowing, the document layout designer then groups the content pages into a page-group element, then specifies the page-group element to skip its display at the large key-frame window size and the full-size content element to skip its display at the small key-frame window size. The last step involves the document layout designer creating a separator-key-frame at the window size between the large and the small window size where the resized full-size version begins to overflow.

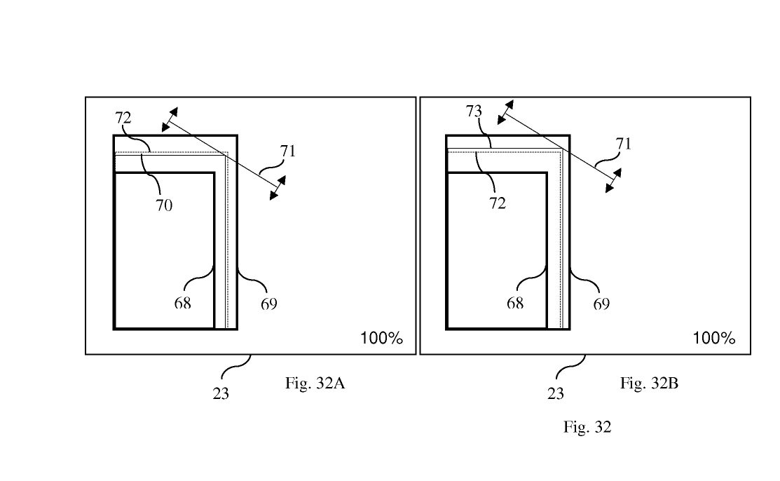

FIG. 32A-32B contrast the effect to the closest-matching key-frame computation before and after the addition of the separator-key-frame. In particular, the box 68 shows the key-frame size of 320×480 while the box 69 shows the key-frame size of 400×600. Between these two key-frame sizes, the implicit dividing size for the closest-matching key-frame computation is the key-frame size of 360×540 as shown by the box 70. The line 71 shows how the closest-matching key-frame computation divides the window sizes graphically. In particular, if the top-right corner of the runtime window size in terms of width×height is north-east of the dividing line 71, the key-frame box 69 of 400×600 will be the closest-matching bounding size, and if the top-right corner of the runtime window is south-west of the dividing line 71, the key-frame box 68 of 320×480 will be the closest-matching bounding size.

At a window size of 370×550 which is the size of the key-frame window 31 in FIG. 31B and shown here as the key-frame box 72, its top-right corner is north-east of the dividing line 71 and as such the closest-matching key-frame box is the box 69 of 400×600 without the separator-key-frame.

FIG. 32B shows that with the addition of a separator-key-frame 380×560 as represented by the box 73, the dividing line 71 is pushed north-east and the top-right corner of the key-frame box 72 becomes south-west of it. In particular, at a runtime window size of 370×550 as represented by the key-frame box 72, the closest-matching key-frame box is the separator-key-frame box 73. In order to compute the correct closest key-frame box of the runtime document window after taking the separator-key-frame box 73 into account, a bounding key-frame computation is needed by the closest-matching key-frame algorithm because by merely using the second closest-matching key-frame box relative to the key-frame box 72, the box 69 will be incorrectly computed as closest-matching. By applying a bounding key-frame computation relative to the key-frame box 72 and the separator-key-frame box 73, the box 68 is correctly computed as the closest-matching bounding key-frame.

It is important to note that an advantageous implementation of the key-frame-group interpolation prefers interpolating over extrapolating layouts between key-frames to generate the effective layout for an element displaying in a runtime document window. As a result, the closest-matching key-frame and its bounding key-frame instead of the second closest-matching key-frame are preferred for key-frame-group interpolation calculation.

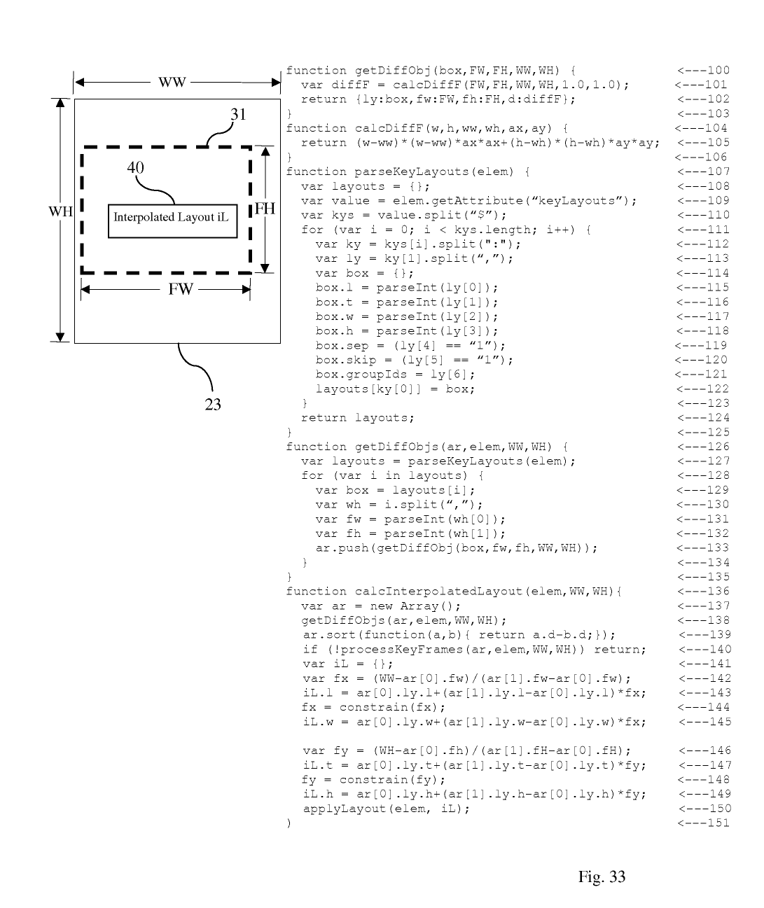

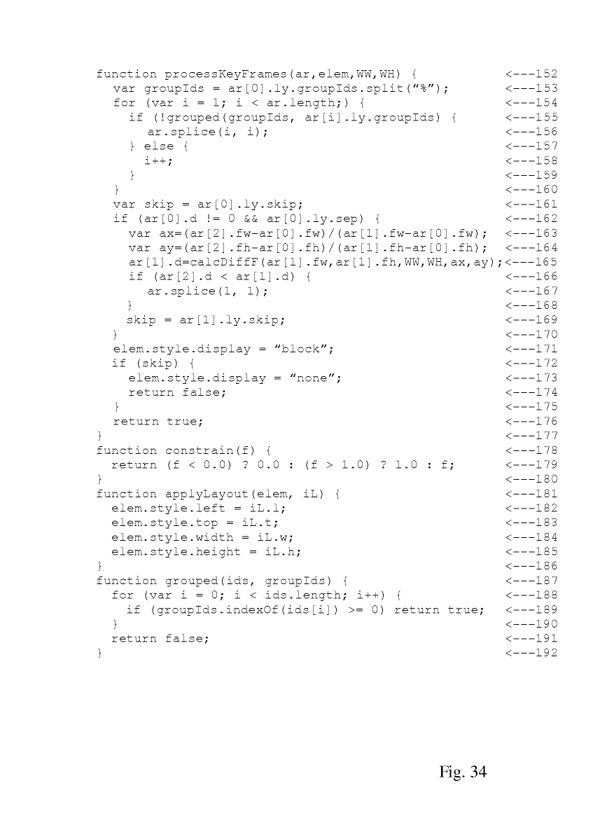

FIG. 33 and FIG. 34 illustrate exemplary JavaScript functions used in the closest matching key-frame-group interpolation for computing interpolated layouts during document window resizing used both by the Javascript 21 of the browser-based editor 11 and the Javascript 24 of the runtime browser 13. In particular, the browser window 23 is the runtime document window with a size of WW in width and WH in height loaded with the text element 40 having recorded its layout and style in the key-frame window 31 at a key-frame size of FW×FH. Because the key-frame window 31 is not created in the browser window 23, it is drawn with a dotted outline inside the browser window 23.

The goal of the JavaScript functions is to calculate the interpolated layout, called iL, for the text element 40. In particular, the goal of the function getDiffObj of line 100 to line 103 is to compute a difference factor, called the diffF, between a particular key-frame size FW×FH and a runtime document window size WW×WH. The lower the value of the diffF, the better matched the key-framed layout is for display at the document window size.

Still referring to FIG. 33, regarding the parameters of the getDiffObj function of line 100, the box object is the layout size of a document element mapped to the key-frame size as described by the FW width and FH height parameters. The box object defines a left, top, width, and height parameter for a particular document element's layout in terms of the l, t, w, and h members. In addition, the box object also defines a “sep”, a “skip” and a “groupIds” member. The “sep” member describes whether the current key-frame is a separator-key-frame. The “skip” member describes whether the key-framed element will skip its display should the current key-frame be selected as the closest-matching key-frame. The “groupIds” member describes the key-frame groups the current key-frame of FW×FH belongs to. Note that a single key-frame can belong to more than one key-frame group and as a result the “groupIds” may contain multiple group ids. The WW and WH are the current window's width and height respectively.

Referring to FIG. 33, if the getDiffObj function is to compute the diffF value for the resized key-frame window 31 of FIG. 14, the WW and WH will be equal to FW4 and FH4 for the width and height of the resized key-frame window 31 of FIG. 14.

Still referring to FIG. 33 for line 101, the diffF value describes how different the current window is from the key-frame size and it is computed by calling the calcDiffF function which is defined by Line 104 to 106. In particular, the calcDiffF function simply computes the diffF by computing distance square between the frame size and the window size. The ax and ay are adjustments to the distance square calculation in the case of a separator-key-frame so that a bounding key-frame can be computed mathematically, but for a first pass closest-matching computation, no adjustments are applied and the ax and ay are passed 1.0 as seen on line 101.

Still referring to FIG. 33, at the end of the computation described by line 102, the function getDiffObj creates and returns an object that references the box object, the FW, FH, and the diffF, and this object is a layout sorting candidate for finding the closest matching key-frame sizes relative to the runtime document window size.

Still referring to FIG. 33, the function parseKeyLayouts of the line 107 to 125 creates a layouts object that extracts all the key-framed layouts info for a key-framed element based on its “keyLayouts” attribute value. In particular, the “keyLayouts” attribute value is encoded in the format of “fw,fh:l,t,w,h,sep,skip,groupIds,CSS,others” where the fw and fh strings represent the key-frame size in terms of width and height. In addition, the “l, t, w, h” string represents the left, top, width and height of the key-framed element's layout size associated with the key-frame size. The “sep” flag indicates whether the key-frame fw×fh is a separator-key-frame. When the “sep” flag is defined as “l”, the key-frame fw×fh is a separator-key-frame that precisely defines the transition point between two closest-matching bounding key-frames for skip-display mapping calculations. The “skip” flag indicates whether the key-framed element will skip its display if the key-frame size fw×fh is the closest-matching key-frame size, or the closest-matching bounding key-frame size if the key-frame size fw×fh is a separator-key-frame.

The “groupIds” string describes the key-frame groups the key-frame fw×fh belongs to. The CSS string represents the recorded key-framed element's CSS style values associated with the key-frame size. In an advantageous implementation, CSS style attributes like font-size, color, background-color, border-width, margins, padding, and opacity may all be recorded and used to compute the interpolated CSS for a key-framed element during resizing. On the other hand, CSS attributes like font-family, font-weight and other non-numerical attributes may not be interpolated through weighted computation, but the present invention does not preclude more sophisticated algorithms for implementing domain-specific interpolation solutions for these attributes. Last but the not the least, the “others” attribute captures other attributes of the key-framed element at key-frame sizes that may be used for interpolation computation. Examples of the “other” attributes include WebKit transforms supported by WebKit-based browsers and SVG coordinates for vector graphics.

Still referring to FIG. 33, line 107 shows a key-framed element called elem passed to the parseKeyLayouts function as an input parameter. Line 108 creates a layouts object that is used as an associative array mapping key-frame sizes to layout box objects. Line 109 and 110 extract the “keyLayouts” attribute value from elem and creates a string array kys by splitting the attribute value based on the delimiting ‘$’ character. Each element of the kys array is a string encoded in the format of “fw,fh:l,t,w,h,sep,skip,groupIds,CSS,others”. Line 111 to 113 iterate through the kys array to extract the “l,t,w,h,sep,skip,groupIds,CSS,others” string mapped to each “fw,fh” string. Line 114 creates a box object, while line 115 to 118 convert the “l,t,w,h” string into respective integer members of the box object. Line 119 extracts the flag that indicates whether the key-frame at fw×fh is a separator-key-frame and assigns it to the box object as the “sep” member. Line 120 extracts the flag that indicates whether key-framed element will skip its display at the key-frame at fw×fh and assigns it to the box object as the “skip” member. Line 121 assigns the extracted “groupIds” string of the key-frame at fw×fh to the box object. Line 122 maps the “fw,fh” member of the layouts object to the box object. Line 124 returns the layouts object that is used as an associative array mapping key-frame sizes to layout box objects.

Still referring to FIG. 33, line 126 to 135 shows a getDiffObjs function that is passed an empty array ar, a key-framed element elem, and the current window width and height as WW and WH. The getDiffObjs' purpose is to iterate through all the elem's key-framed layouts and convert them into layout sorting candidates that are inserted into the ar array. In particular, line 127 calls the parseKeyLayouts function to extract the key-framed layouts object from the elem element. Line 128 to 132 iterate through the layouts and convert the key-frame width and height “fw,fh” string into fw and fh integers. Line 133 computes a layout sorting candidate per key-framed layout and inserts it into the ar array.

Still referring to FIG. 33, the function calcInterpolatedLayout of line 136 to 151, typically initiated by the window's resizing callback function to process all key-framed elements in a runtime document window, computes the closest matching key-frame sizes relative to the current window width WW, and height WH for each key-framed element as the elem parameter. In particular, line 137 creates an array which is populated with the layout sorting candidates returned by calling getDiffObjs at line 138. Line 139 sorts this array such that the layout sorting candidate with the lowest diffF value is ranked first. Line 140 calls the processKeyFrames function to apply further key-frame-group resizing, separator key-frame, and skip-display mapping rules to the layout sorting candidates.

In particular, referring to FIG. 34, the first ar parameter passed to the function processKeyFrames at line 152 contains the sorted layout array while the second elem parameter refers to the corresponding key-framed element. The WW and WH describe the runtime document window width and height respectively. Line 153 to 160 implement the key-frame-group resizing as described by FIG. 5 to FIG. 9. In particular, the key-frame group ids of the first key-framed layout is parsed as an array and assigned to a local variable at line 153, and this group id array is used as a filtering criterion for eliminating the key-framed layouts not belonging to the same key-frame groups, as described by line 154 to 160.

Referring back to FIG. 3 and FIG. 4, the key-frame group 33 and 34 are each assigned a unique group id, called the “groupId” in the exemplary browser-based editor 11, and this “groupId” is used by the processKeyFrames function to implement key-frame-group resizing. Moreover, when a new customized key-frame is created as in FIG. 13, the newly created key-frame is assigned the currently selected key-frame “groupId”. On the other hand, referring to FIG. 17, the newly created separator-key-frame 50 defines its own group id and this id is added to the existing group ids of its closest-matching bounding key frame 35 and 37.

Note that since the exemplary browser-based editor 11 supports a key-frame to be contained by more than one key-frame group, line 155 checks to see if there is any intersection between the group ids of a key-framed layout and those from the first key-framed layout by calling the function grouped of line 187 to 192. If there is no intersection, the key-framed layout is filtered as shown on line 156.

Line 161 to 177 provide an exemplary implementation of the bounding key-frame discovery and skip-display mapping computation in the presence of a separator-key-frame layout. As shown on line 161, the skip variable is first initialized by the first sorted layout object, and as shown on line 162, the closest-matching layout, ar[0].d, which defines the diffF factor for describing how different the first key-frame size is relative to the runtime document window's, is checked and as long as it is not zero as reflected by the condition “ar[0].d !=0”, and if the first key-frame defines a separator-key-frame as reflected by the condition “&& ar[0].ly.sep”, the bounding key-frame discovery and skip-display mapping computation will be further processed by line 163 to 169. For the bounding key-frame discovery defined by line 163 to 168, the diffF computation between the runtime window and the second closest-matching layout is adjusted by the weighted difference between the third and the second closest-matching layouts relative to the separator layout, as shown by line 163 to 165. After the weighted adjustments, if the d member which represents the diffF factor of the third closest-matching layout is less than that from the second closest-matching layout as shown on line 166, the second closest-matching layout is deleted as shown on line 167 and the third closest-matching layout becomes the bounding key-frame layout of the separator-key-frame and it defines the skip-display mapping as shown on line 169. Line 171 makes the elem's CSS visible unless the skip parameter is true, in which case the elem's CSS is made invisible and the processKeyFrames function returns false, as shown by line 173 to 174. Line 176 returns true if the skip parameter is false, and this Boolean flag returned by the processKeyFrames function indicates that the caller should proceed because the key-framed element will join the display.

Referring back to FIG. 33, after calling the processKeyFrames function at line 140, if the processKeyFrames returns false, meaning the elem is to skip its display for the current runtime window size WW×WH, no further interpolation processing is necessary and the control flows back to the caller which processes the next key-framed element in the runtime document window.

If the processKeyFrames function returns a true flag at line 140 to indicate that the key-framed element will join the display, processing continues at line 141 which creates an iL object to represent the interpolated layout object. Line 142 computes the scale factor fx for the interpolated layout in the X-dimension by computing WW relative to the closest matching and bounding key-frame widths from the same key-frame group. Based on the fx scale factor, line 143 computes the left position of the interpolated layout iL. Line 144 calls a constrain function to constrain the fx scale factor before applying it to compute the width of the interpolated layout at line 145. For an exemplary implementation the scaled width and height of a resized layout always fall between those specified at the two closest-matching key-frame sizes, the constrain function defined by line 178 to 180 of FIG. 34 implements this effect by bounding the scale factor to be between 0.0 and 1.0 to produce such mathematical results for line 145 and line 149.

Line 146 to 149 repeat the same key-frame-group interpolation computation for the elem's layout for the Y-dimension. Line 150 calls the applyLayout method to transfer the interpolated layout iL to the document element elem, and because the elem is an HTML document element with absolute positioned layout, transferring the interpolated layout iL to the elem is done by assigning iL's position and size to the elem's corresponding CSS layout parameters as described by the applyLayout function from line 181 to 186 of FIG. 34.

Even though the exemplary code described by FIG. 33 and FIG. 34 focuses on computing the position and size of an interpolated key-framed layout only, those skilled in the art of the document layout technology can easily adapt these functions for CSS and other attribute's interpolation computation.

In particular, still referring to FIG. 33, even though the calcInterpolatedLayout function defined by line 136 only computes the interpolated layout for elem, those skilled in the art of document layout technology can easily adapt it as calcInterpolatedCSS and calcInterpolatedOthers to compute an interpolated CSS and other attributes like those for controlling SVG graphics at a particular resized window width and height of WW and WH. It is important to note that while FIG. 10 to FIG. 12 provide scenarios where font size differences are used as an example of numerical CSS attribute captured and interpolated during the key-frame interpolated resizing, these scenarios can easily be extended to cover cases involving other CSS, SVG graphics, transform-based, and non-numerical attribute interpolations.

Still referring to FIG. 33 and FIG. 34, even though the exemplary code only uses the two closest matching key-frames from the same key-frame group for key-frame-group interpolation calculation, the present invention does not preclude other implementations from using the N closest matching key-frames from the same key-frame group where N is a number greater than or equal to two. Moreover, even though the exemplary code computes both the position and the size of an element's effective layout because the element is assumed to be absolutely positioned through CSS, the exemplary code can be easily adapted to generate interpolated text layouts by interpolating and calculating just the size of an element's effective layout.

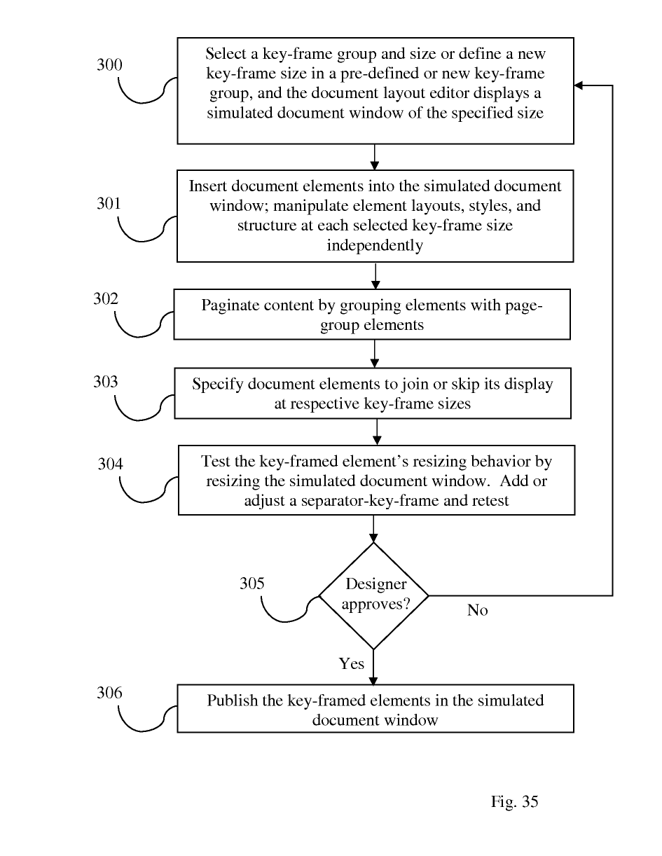

FIG. 35 illustrates the flowchart of the present invention for the authoring of key-framed document layout resizing behavior from a document layout designer's point of view. In particular, Step 300 describes the first step where a document layout designer selects a key-frame size from pre-defined groups of key-frame sizes or defines a new key-frame size in a pre-defined or a newly defined key-frame group in a document layout editor, and the document layout editor displays a simulated document window with the corresponding size for inserting and manipulating document elements. If such a key-frame window already exists, the document layout editor resizes it to the selected key-frame size.

Step 301 describes the next step where the document layout designer inserts one or more document elements into the simulated document window and manipulates their layout, style, and other attributes at each selected key-frame size independently, and the document layout editor records each element's manipulated layouts, styles, and other attributes mapped to the respective key-frame sizes as element attributes and values

Step 302 describes the next step where the document layout designer paginates the selected elements by a page-group element to generate paginated content in the runtime document window.

Step 303 describes the next step where the document layout designer specifies the selected document elements to join or skip its display at respective key-frame sizes.

Note that the Step 301 to Step 303 describe the editing mode where the document layout editor's simulated document window facilitates the authoring of the key-framed document content and as such the skip-display mapping and the paging algorithms are disabled, but the closest-matching key-frame-group interpolation algorithm is still enabled so that the simulated document window can more faithfully reproduce the runtime document window's layout resizing behavior to assist the authoring process.

Step 304 describes the next step where the document layout designer tests the key-frame element's resizing behavior by resizing the key-frame window. Note that the Step 304 describes the testing mode where the document layout editor facilitates the testing of the resizing behavior of the key-framed elements and as such the skip-display mapping and the paging algorithms are enabled. To precisely customize the separation-points for the skip-display mapping behavior, the document layout designer may add or adjust a separator-key-frame between two key-frames and re-test the key-framed element's resizing behavior.

Note also that step 301 to 304 may be performed in any order in an exemplary editor of the present invention.

If the document layout designer approves of the resizing behavior of the key-framed elements as described by Step 305's “Yes” branch, the document layout designer publishes the key-framed elements as described by Step 306. The publishing of the key-framed elements involves saving the tree of key-framed elements of the key-frame window into persistence storage.

In the case where the edited document elements are represented in HTML, the publishing of the key-framed elements involves the browser-based editor sending the key-framed HTML encapsulating all the key-framed data stored in the respective key-framed elements' attributes to the web server for persistence storage. The web server may strip any editor-specific information embedded in the HTML and persists the stripped HTML as a published HTML optimized for viewing. A published key-framed HTML will later be loaded in a runtime browser to reproduce the closest matching key-frame-group interpolated resizing, skip-display mapping and adaptive-pagination behaviors.

Still referring to FIG. 35, if the document layout designer does not approve of the resizing behavior of the key-framed document elements as described by Step 305's “No” branch, the document layout designer goes back to Step 300 and manipulates the key-framed elements further.

Note that Step 304 and Step 305 are recommended in an exemplary embodiment of the present invention, but the present invention does not preclude an embodiment where Step 303 is immediately followed by Step 306, in which case the testing of the published document will be performed in a runtime document window, but such an embodiment will incur the publishing and loading roundtrip overhead on every incremental change to a key-framed element requiring testing.

It is important to note that even though that key-framed layouts, styles, separator-key-frames, key-frame groupings, and page-group elements are created through the browser-based editor 11 in an exemplary embodiment, the present invention recognizes that programmatic creation of such elements, attributes, and structure in a document is possible and even preferable in other embodiments.

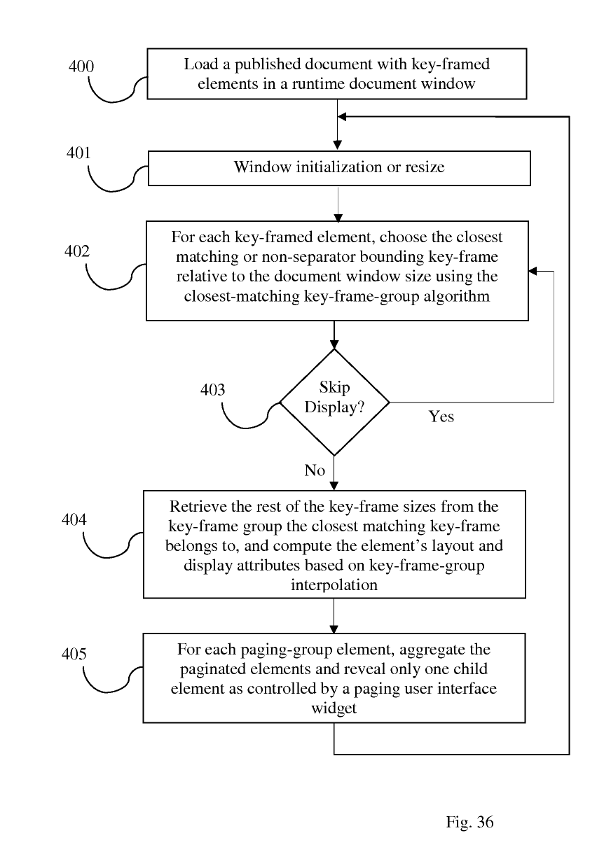

FIG. 36 illustrates the flowchart of the present invention for the processing of a key-framed document loaded in a runtime document window to generate the closest-matching key-frame-group interpolated-resizing, adaptive layout and pagination. In particular, Step 400 describes the first step where a user opens and loads a published document with key-framed elements into a runtime document window.

Step 401 describes the next step where the document window loaded with key-framed elements initializes or resizes.

Step 402 to Step 404 describe the next steps where a callback function corresponding to a window-initialize or window-resize event performs the following actions:

Step 402 describes the step where for each key-framed element the runtime document window chooses the closest matching key-frame or the non-separator bounding key-frame relative to the size of the runtime document window using the closest-matching key-frame-group algorithm.

Step 403 describes the next step which is a conditional step where the computed closest-matching key-frame from Step 402 is checked to see if the key-framed element is specified to skip its display. If yes, processing follows Step 403's “Yes” branch to flow back to Step 402 to process the next key-framed element. If the key-framed element is specified to display, processing follows Step 403's “No” branch to continue at the Step 404.

Step 404 describes the next step where the runtime document window retrieves the rest of the key-frame sizes from the key-frame group the closest matching key-frame belongs to, and computes the element's layout and display attributes based on key-frame-group interpolation.

Step 405 describes the next step where for each paging-group element, the runtime document window aggregates the paginated elements and reveals only one child element as controlled by a paging user interface widget. Note that multiple levels of page-group elements may be aggregated recursively and controlled by a single paging user interface widget.

After Step 405 completes, the processing flows back to Step 401 and waits for the next window resize event.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A method for generating a resizable layout of a document element loaded in a runtime document window comprising:
a) loading mappings consisting of recorded layouts between said document element and at least four different reference window sizes that are pre-grouped into at least two reference window groups with each said reference window group containing at least two said reference window sizes
b) numerically computing how different each said reference window size is compared to said runtime document window size, and sorting all said reference window sizes based on said numeric differences to determine the closest-matching reference window size;
c) identifying the reference window group corresponding to the closest-matching reference window size and selecting a second closest-matching reference window size belonging to the same reference window group from said sorted reference window sizes;
d) generating the effective layout for said document element by interpolating said mapped layouts corresponding to said closest-matching and said second closest-matching reference window sizes to said runtime document window size;

2. The method of claim 1 further comprising:
a) said recorded and generated layouts consisting of sizes and positions;
b) said recorded and generated layouts consisting of display styles such as font and border size;

3. The method of claim 1 further comprising:
a) said recorded and generated layouts defined by Cascading Style Sheet;

4. The method of claim 1 further comprising:
a) said reference window groupings identified explicitly by unique group ids in said runtime document window;

5. The method of claim 1, further comprising:
a) said reference window groupings identified implicitly by grouping said reference window sizes with similar geometric property such as aspect ratio;

6. The method of claim 1, further comprising::
a) said loaded mappings consisting of display-skipping hints between said document element and said reference window sizes;
b) using the display-skipping hint associated with the loaded mapping between said document element and said closest-matching reference window size to determine whether said document element will join or skip its display in said runtime document window;

7. The method of claim 6, further comprising:
a) using the display-skipping hint associated with the loaded mapping between said document element and said closest-matching bounding reference window size relative to said closest-matching reference window size and said runtime document window size to determine whether said document element will join or skip its display in said runtime document window if said closest-matching reference window size defines a dividing reference window size for the closest-matching computation between two reference window sizes;

8. The method of claim 6, further comprising:
a) said document element is a group element which resizes its child elements proportionately in said runtime document window;
b) said group element revealing one of its child elements in said runtime document window while hiding the rest of its child elements wherein said revealed child element is controlled by a user interface widget created in said runtime document window;

9. A method for constructing a resizable layout of a document element loaded in a runtime document window comprising:
a) an editor with a simulated window that lets a user set the size of said simulated window to any one of at least four reference window sizes where said reference window sizes are grouped into at least two reference window groups with each reference window group containing at least two of said reference window sizes;
b) said editor that lets said user create and edit said document element's layout inside said simulated window at said user-set reference window sizes;
c) said editor that records the edited element layouts of said edited element as mapped to said user-set reference window sizes respectively;
d) said editor that lets said user publish said edited element with said recorded layouts mapped to said user-set reference window sizes respectively to persistent storage;
e) said runtime document window that reconstitutes said reference window sizes and said reference window groups;
f) said runtime document window that loads said published document element and said recorded layouts mapped to said user-set reference window sizes respectively;
g) said runtime document window that generates an effective layout for said loaded document element by interpolating said loaded layouts mapped to the closest-matching reference window sizes relative to said runtime document window size, wherein said closest-matching reference windows sizes belong to the same reference window group;

10. The method of claim 9, further comprising:
a) said recorded and generated layouts consisting of sizes and positions;
b) said recorded and generated layouts consisting of display styles such as font and border size;

11. The method of claim 10, further comprising::
a) said recorded and generated layouts defined by Cascading Style Sheet;

12. The method of claim 9, further comprising::
a) said reference window groupings identified explicitly by unique group ids in said editor and said runtime document window;

13. The method of claim 9, further comprising:
a) said reference window groupings identified implicitly by grouping said reference window sizes with similar geometric property such as aspect ratio;

14. The method of claim 9 further comprising:
a) said editor that lets said user create a customized reference window size;
b) said customized reference window size contributing to said plurality of reference window sizes with respective said mappings consisting of recorded layouts for said document element;
c) said editor that lets said user delete said customized reference window size;

15. The method of claim 9, further comprising:
a) said editor that lets said user specify a display-skipping hint as mapped to a reference window size for said document element such that if said reference window size is computed to be the closest-matching reference window size relative to said runtime document window, said document element will join or skip its display based on said display-skipping hint in said runtime document window;

16. The method of claim 15, further comprising:
a) said editor that lets said user create a dividing reference window size between two said reference window sizes such that if said dividing reference window size is computed to be the closest-matching reference window size relative to said runtime document window size, the loaded mapping corresponding to the closest-matching bounding reference window size relative to said closest-matching reference window size and said runtime document window size will be used to derive said display-skipping hint;

17. The method of claim 9, further comprising:
a) said editor that lets said user group a plurality of selected elements into a group element wherein said group element resizes its child elements proportionately when loaded and resized in said runtime document window;
b) said group element revealing one of its child elements when loaded in said runtime document window while hiding the rest of its child elements, wherein said revealed child element is controlled by a user interface widget created in said runtime document window;

18. The method of claim 9, wherein providing said editor with said simulated document window for creating and manipulating said document element, further comprising:
a) letting said user test the resizing behavior of said edited document element by resizing said simulated document window to any window size;
b) said simulated document window faithfully reproducing the resizing behavior of said document element when loaded into said runtime document window;

19. A method for generating an adaptive layout of a document element loaded in a runtime document window comprising:
a) loading mappings consisting of display-skipping hints between said document element and at least two reference window sizes;
b) numerically computing how different each said reference window size is compared to said runtime document window size, and sorting all said reference window sizes based on said numeric differences to determine the closest-matching reference window size;
c) using the display-skipping hint associated with the loaded mapping corresponding to said closest-matching reference window size to determine whether said document element will join or skip its display in said runtime document window;

20. The method of claim 19, wherein using the display-skipping hint associated with the loaded mapping corresponding to said closest-matching reference window size to determine whether said document element will join or skip its display in said runtime document window, further comprising:
a) using the display-skipping hint associated with the loaded mapping between said document element and said closest-matching bounding reference window size relative to said closest-matching reference window size and said runtime document window size to determine whether said document element will join or skip its display in said runtime document window if said closest-matching reference window size defines a dividing reference window size for the closest-matching computation between two reference window sizes; [symbol]
